(19) United States
(12) Patent Application Publication
(10) Pub. No.: US 2026/0141664 A1
(43) Pub. Date: May 21, 2026

(54) ELECTRONIC DEVICE, METHOD, AND COMPUTER-READABLE STORAGE MEDIUM FOR CHANGING SCREEN ON BASIS OF SWITCHING OF VIRTUAL SPACE

(71) Applicant: Samsung Electronics Co., Ltd., Suwon-si (KR)

(72) Inventors: Sunghoon YIM, Suwon-si (KR); Myoungwoo NAM, Suwon-si (KR); Hyunsoo KIM, Suwon-si (KR); Jeaguk SHIM, Suwon-si (KR); Nagyeom YOO, Suwon-si (KR); Yoonho LEE, Suwon-si (KR)

(21) Appl. No.: 19/450,435

(22) Filed: Jan. 15, 2026

Related U.S. Application Data
(63) Continuation of application No. PCT/KR2024/007589, filed on Jun. 3, 2024.

(30) Foreign Application Priority Data
Jul. 25, 2023 (KR) 10-2023-0097075
Sep. 14, 2023 (KR) 10-2023-0122798

(51) Int. Cl. G06T 19/20; G06F 3/01; G06V 10/60

(52) U.S. Cl. CPC G06T 19/20; G06F 3/013; G06V 10/60; G06T 2219/2004

(57) ABSTRACT

A wearable device may include: a display; a camera; at least one sensor; a memory for storing instructions; and at least one processor. The at least one processor may be configured to, when the instructions are executed, display a first screen related to a first virtual space while the display mode of the display is in a first display mode. The at least one processor may be configured to, when the instructions are executed, identify information about an external environment in which the wearable device is located. The at least one processor may be configured to, when the instructions are executed, identify that the display mode of the display is changed from the first display mode to a second display mode. The at least one processor may be configured to identify a second screen related to a second virtual space according to the second display mode. The at least one processor may be configured to, when the instructions are executed, display a third screen changed from the second screen, while the display mode of the display is in the second display mode.

### CROSS-REFERENCE TO RELATED APPLICATIONS

This application is a continuation application of International Application No. PCT/KR2024/007589, filed on Jun. 3, 2024, in the Korean Intellectual Property Receiving Office, and claiming priority to Korean Patent Application No. 10-2023-0097075 filed Jul. 25, 2023 and to Korean Patent Application No. 10-2023-0122798 filed Sep. 14, 2023, the disclosures of which are all hereby incorporated by reference herein in their entireties.

### BACKGROUND

### Field

Certain example embodiments may relate to an electronic device, a method, and/or a computer readable storage medium for changing a screen based on switching of a virtual space.

### Description of Related Art

In order to provide an enhanced user experience, an electronic device that provides augmented reality (AR) and/or virtual reality (VR) services displaying information generated by a computer linked to an external object in the real-world is being developed. The electronic device may be a wearable device that may be worn by a user. For example, the electronic device may be AR glasses and/or a head-mounted device (HMD).

The above-described information may be provided as a related art for the purpose of helping understanding of the present disclosure. No argument or decision is made as to whether any of the above description may be applied as a prior art related to the present disclosure.

### SUMMARY

According to an example embodiment, a wearable device may comprise a display, a camera, at least one sensor, memory, storing instructions, comprising one or more storage media, and at least one processor comprising processing circuitry. The instructions, when executed by the at least one processor individually and/or collectively, may cause the wearable device to display a first screen related to a first virtual space through/via the display while a display mode of the display is a first display mode. The instructions, when executed by the at least one processor individually and/or collectively, may cause the wearable device to identify information regarding external environment in which the wearable device is located, while at least one screen related to the first virtual space including the first screen is displayed. The instructions, when executed by the at least one processor individually and/or collectively, may cause the wearable device to, after the information regarding the external environment is identified, identify that the display mode of the display is changed from the first display mode to a second display mode. The instructions, when executed by the at least one processor individually and/or collectively, may cause the wearable device to, based on identifying that the display mode of the display is changed from the first display mode to the second display mode, identify a second screen related to a second virtual space according to the second display mode. The instructions, when executed by the at least one processor individually and/or collectively, may cause the wearable device to display a third screen changed from the second screen through the display while the display mode of the display is the second display mode, based on the information regarding the external environment and a first area in the second screen identified according to a gaze of a user of the wearable device.

According to an example embodiment, a method of a wearable device may comprise displaying a first screen related to a first virtual space through the display while a display mode of the display is a first display mode. The method may comprise identifying information on external environment in which the wearable device is located, while at least one screen related to the first virtual space including the first screen is displayed. The method may comprise, after the information on the external environment is identified, identifying that the display mode of the display is changed from the first display mode to a second display mode. The method may comprise, based on identifying that the display mode of the display is changed from the first display mode to the second display mode, identifying a second screen related to a second virtual space according to the second display mode. The method may comprise displaying a third screen changed from the second screen through the display while the display mode of the display is the second display mode, based on the information on the external environment and a first area in the second screen identified according to a gaze of a user of the wearable device.

According to an embodiment, a non-transitory computer readable storage medium may store one or more programs. The one or more programs may comprise instructions, which, when executed by at least one processor of a wearable device with a display, a camera, and at least one sensor, cause the wearable device to display a first screen related to a first virtual space through the display while a display mode of the display is a first display mode. The one or more programs may comprise instructions, which cause the wearable device to identify information on external environment, while at least one screen related to the first virtual space including the first screen is displayed. The one or more programs may comprise instructions, which cause the wearable device to, after the information on the external environment is identified, identify that the display mode of the display is changed from the first display mode to a second display mode. The one or more programs may comprise instructions, which cause the wearable device to, based on identifying that the display mode of the display is changed from the first display mode to the second display mode, identify a second screen related to a second virtual space according to the second display mode. The one or more programs may comprise instructions, which cause the wearable device to display a third screen changed from the second screen through the display while the display mode of the display is the second display mode, based on the information on the external environment and a first area in the second screen identified according to a gaze of a user of the wearable device.

### BRIEF DESCRIPTION OF THE DRAWINGS

FIG. 1 is a block diagram of an electronic device in a network environment according to an example embodiment.

FIGS. 2A and 2B illustrate an example of a perspective view of a wearable device according to an embodiment.

FIGS. 3A and 3B illustrate an example of an exterior of a wearable device according to an embodiment.

FIG. 4 illustrates an example of a block diagram of a wearable device according to an embodiment.

FIG. 5 illustrates an example of virtual spaces changed according to a display mode of a display according to an embodiment.

FIG. 6A illustrates a flowchart of an operation of a wearable device according to an example embodiment.

FIG. 6B illustrates a flowchart of an operation of a wearable device according to an example embodiment.

FIG. 7A illustrates a flowchart of an operation of a wearable device according to an example embodiment.

FIG. 7B illustrates an example of an operation of identifying a position where a light source is disposed within a space where a wearable device is located, according to an embodiment.

FIG. 8 illustrates a flowchart of an operation of a wearable device according to an example embodiment.

FIG. 9 illustrates a flowchart of an operation of a wearable device according to an example embodiment.

FIG. 10 illustrates an example of an operation of a wearable device according to an example embodiment.

FIG. 11 illustrates an example of an operation of a wearable device according to an example embodiment.

FIG. 12 illustrates an example of an operation of a wearable device according to an example embodiment.

FIG. 13 illustrates an example of an operation of a wearable device according to an example embodiment.

### DETAILED DESCRIPTION

Hereinafter, an embodiment of the present disclosure is described in detail with reference to the drawings such that those having ordinary knowledge in the art to which the present disclosure belongs, may easily implement it. However, the present disclosure may be implemented in various different forms and is not limited to an embodiment described herein. Regarding descriptions of the drawings, the same or similar reference numerals may be used for the same or similar components. In addition, in the drawings and related descriptions, descriptions for well-known functions and configurations may be omitted for clarity and conciseness.

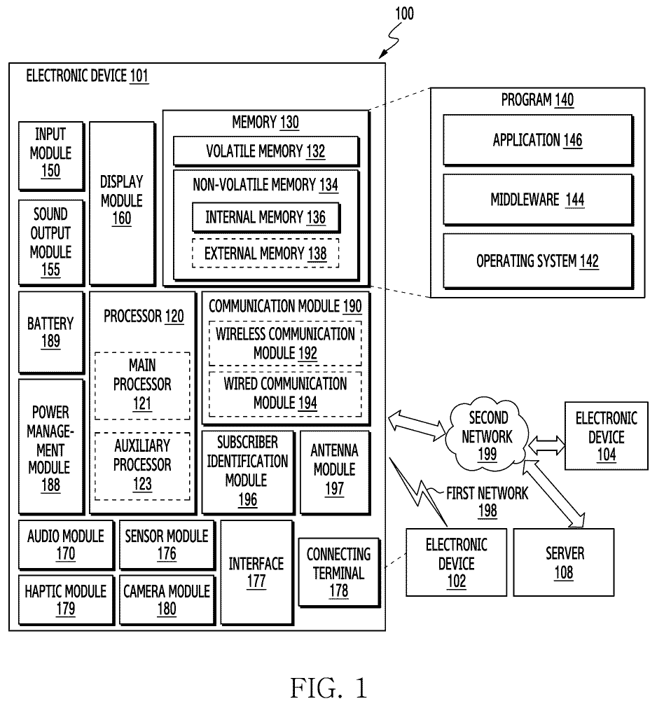

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120, comprising processing circuitry, may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 (comprising processing circuitry) and the auxiliary processor 123 (comprising processing circuitry), the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected, directly or indirectly, with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101.

The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

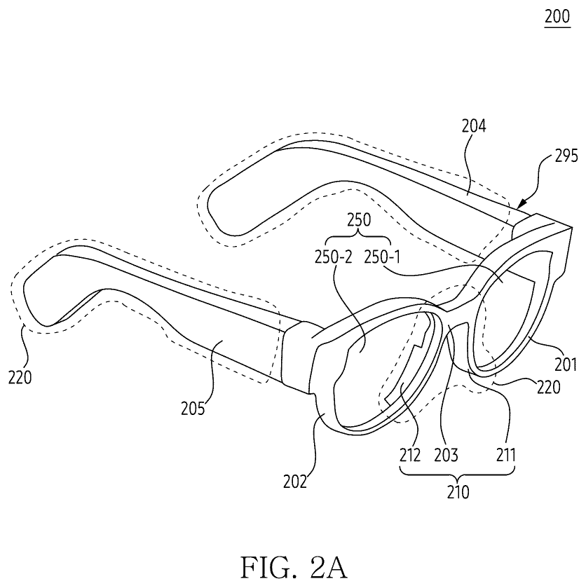

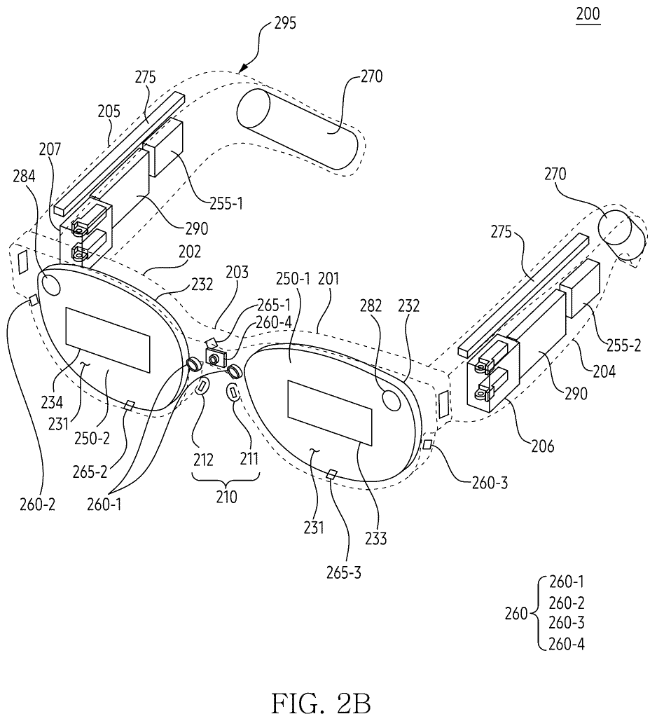

FIGS. 2A and 2B illustrate an example of a perspective view of a wearable device according to an embodiment.

According to an embodiment, a wearable device 200 may have a form of glasses that is wearable on a body part (e.g., head) of a user. The wearable device 200 of FIGS. 2A to 2B may be an example of the electronic device 101 of FIG. 1. The wearable device 200 may include a head-mounted display (HMD). For example, a housing of the wearable device 200 may include a flexible material such as rubber and/or silicone having a form closely attached to a portion of the user's head (for example, a portion of a face surrounding two eyes). For example, the housing of the wearable device 200 may include one or more straps able to be twined around the user's head, and/or one or more temples attachable to ears of the head.

Referring to FIG. 2A, according to an embodiment, the wearable device 200 may include at least one display 250 and a frame 200 supporting the at least one display 250.

According to an embodiment, the wearable device 200 may be wearable on a portion of the user's body. The wearable device 200 may provide augmented reality (AR), virtual reality (VR), or mixed reality (MR) combining the augmented reality and the virtual reality to a user wearing the wearable device 200. For example, the wearable device 200 may display a virtual reality image provided from at least one optical device 282 and 284 of FIG. 2B on at least one display 250, in response to a user's preset gesture obtained through a motion recognition camera 260-2 and 263 of FIG. 2B.

According to an embodiment, the at least one display 250 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user's left and right eyes, respectively.

Referring to FIG. 2B, the at least one display 250 may provide visual information transmitted through a lens included in the at least one display 250 from ambient light to a user and other visual information distinguished from the visual information2. The lens may be formed based on at least one of a fresnel lens, a pancake lens, or a multi-channel lens. For example, the at least one display 250 may include a first surface 231 and a second surface 232 opposite to the first surface 231. A display area may be formed on the second surface 232 of at least one display 250. When the user wears the wearable device 200, ambient light may be transmitted to the user by being incident on the first surface 231 and being penetrated through the second surface 232. For another example, the at least one display 250 may display an augmented reality image in which a virtual reality image provided by the at least one optical device 282 and 284 is combined with a reality screen transmitted through ambient light, on a display area formed on the second surface 232.

In an embodiment, the at least one display 250 may include at least one waveguide 233 and 234 that transmits light transmitted from the at least one optical device 282 and 284 by diffracting to the user. The at least one waveguide 233 and 234 may be formed based on at least one of glass, plastic, or polymer. A nano pattern may be formed on at least a portion of the outside or inside of the at least one waveguide 233 and 234. The nano pattern may be formed based on a grating structure having a polygonal or curved shape. Light incident to an end of the at least one waveguide 233 and 234 may be propagated to another end of the at least one waveguide 233 and 234 by the nano pattern. The at least one waveguide 233 and 234 may include at least one of at least one diffraction element (e.g., a diffractive optical element (DOE), a holographic optical element (HOE)), and a reflection element (e.g., a reflection mirror). For example, the at least one waveguide 233 and 234 may be disposed in the wearable device 200 to guide a screen displayed by the at least one display 250 to the user's eyes. For example, the screen may be transmitted to the user's eyes based on total internal reflection (TIR) generated in the at least one waveguide 233 and 234.

The wearable device 200 may analyze an object included in a real image collected through a photographing camera 260-4, combine with a virtual object corresponding to an object that becomes a subject of augmented reality provision among the analyzed object, and display on the at least one display 250. The virtual object may include at least one of text and images for various information associated with the object included in the real image. The wearable device 200 may analyze the object based on a multi-camera such as a stereo camera. For the object analysis, the wearable device 200 may execute space recognition (e.g., simultaneous localization and mapping (SLAM)) using the multi-camera and/or time-of-flight (ToF). The user wearing the wearable device 200 may watch an image displayed on the at least one display 250.

According to an embodiment, a frame 200 may be configured with a physical structure in which the wearable device 200 may be worn on the user's body. According to an embodiment, the frame 200 may be configured so that when the user wears the wearable device 200, the first display 250-1 and the second display 250-2 may be positioned corresponding to the user's left and right eyes. The frame 200 may support the at least one display 250. For example, the frame 200 may support the first display 250-1 and the second display 250-2 to be positioned at positions corresponding to the user's left and right eyes.

Referring to FIG. 2A, according to an embodiment, the frame 200 may include an area 220 at least partially in contact with the portion of the user's body in case that the user wears the wearable device 200. For example, the area 220 of the frame 200 in contact with the portion of the user's body may include an area in contact with a portion of the user's nose, a portion of the user's ear, and a portion of the side of the user's face that the wearable device 200 contacts. According to an embodiment, the frame 200 may include a nose pad 210 that is contacted on the portion of the user's body. When the wearable device 200 is worn by the user, the nose pad 210 may be contacted on the portion of the user's nose. The frame 200 may include a first temple 204 and a second temple 205, which are contacted on another portion of the user's body that is distinct from the portion of the user's body.

For example, the frame 200 may include a first rim 201 surrounding at least a portion of the first display 250-1, a second rim 202 surrounding at least a portion of the second display 250-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer's ear, and the second temple 205 extending from the second rim 202 and fixed to a portion of the ear opposite to the ear. The first pad 211 and the second pad 212 may be in contact with the portion of the user's nose, and the first temple 204 and the second temple 205 may be in contact with a portion of the user's face and the portion of the user's ear. The temples 204 and 205 may be rotatably connected, directly or indirectly, to the rim through hinge units 206 and 207 of FIG. 2B. The first temple 204 may be rotatably connected, directly or indirectly, with respect to the first rim 201 through the first hinge unit 206 disposed between at least the first rim 201 and the first temple 204. The second temple 205 may be rotatably connected with respect to the second rim 202 through the second hinge unit 207 disposed between the second rim 202 and the second temple 205. According to an embodiment, the wearable device 200 may identify an external object (e.g., a user's fingertip) touching the frame 200 and/or a gesture performed by the external object by using a touch sensor, a grip sensor, and/or a proximity sensor formed on at least a portion of the surface of the frame 200.

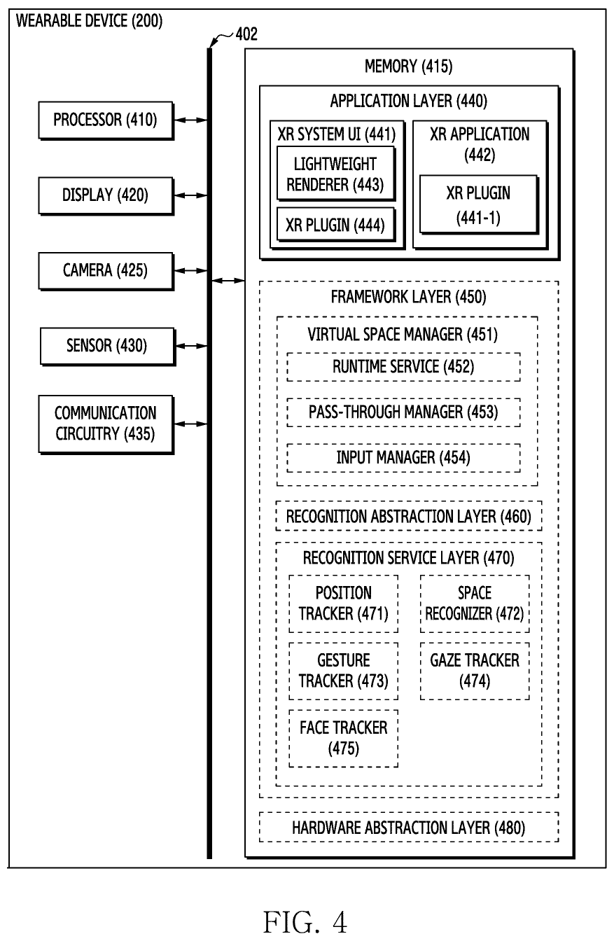

According to an embodiment, the wearable device 200 may include hardware (e.g., hardware to be described later based on the block diagram of FIG. 4) that performs various functions. For example, the hardware may include a battery module 270, an antenna module 275, the at least one optical device 282 and 284, speakers (e.g., speakers 255-1 and 255-2), a microphone (e.g., microphones 265-1, 265-2, and 265-3), a light emitting module (not illustrated), and/or a printed circuit board (PCB) 290 (e.g., printed circuit board). Various hardware may be disposed in the frame 200.

According to an embodiment, the microphone (e.g., the microphones 265-1, 265-2, and 265-3) of the wearable device 200 may obtain a sound signal, by being disposed on at least a portion of the frame 200. The first microphone 265-1 disposed on the bridge 203, the second microphone 265-2 disposed on the second rim 202, and the third microphone 265-3 disposed on the first rim 201 are illustrated in FIG. 2B, but the number and disposition of the microphone 265 are not limited to an embodiment of FIG. 2B. In case that the number of the microphone 265 included in the wearable device 200 is two or more, the wearable device 200 may identify a direction of the sound signal by using a plurality of microphones disposed on different portions of the frame 200.

According to an embodiment, the at least one optical device 282 and 284 may project a virtual object on the at least one display 250 in order to provide various image information to the user. For example, the at least one optical device 282 and 284 may be a projector. The at least one optical device 282 and 284 may be disposed adjacent to the at least one display 250 or may be included in the at least one display 250 as a portion of the at least one display 250. According to an embodiment, the wearable device 200 may include a first optical device 282 corresponding to the first display 250-1, and a second optical device 284 corresponding to the second display 250-2. For example, the at least one optical device 282 and 284 may include the first optical device 282 disposed at a periphery of the first display 250-1 and the second optical device 284 disposed at a periphery of the second display 250-2. The first optical device 282 may transmit light to the first waveguide 233 disposed on the first display 250-1, and the second optical device 284 may transmit light to the second waveguide 234 disposed on the second display 250-2.

In an embodiment, a camera 260 may include the photographing camera 260-4, an eye tracking camera (ET CAM) 260-1, and/or the motion recognition camera 260-2 and 260-3. The photographing camera 260-4, the eye tracking camera 260-1, and the motion recognition camera 260-2 and 260-3 may be disposed at different positions on the frame 200 and may perform different functions. The eye tracking camera 260-1 may output data indicating a position of eye or a gaze of the user wearing the wearable device 200. For example, the wearable device 200 may detect the gaze from an image including the user's pupil obtained through the eye tracking camera 260-1. The wearable device 200 may identify an object (e.g., a real object, and/or a virtual object) focused by the user, by using the user's gaze obtained through the eye tracking camera 260-1. The wearable device 200 identifying the focused object may execute a function (e.g., gaze interaction) for interaction between the user and the focused object. The wearable device 200 may represent a portion corresponding to eye of an avatar indicating the user in the virtual space, by using the user's gaze obtained through the eye tracking camera 260-1. The wearable device 200 may render an image (or a screen) displayed on the at least one display 250, based on the position of the user's eye. For example, visual quality (e.g., resolution, brightness, saturation, grayscale, and PPI) of a first area related to the gaze within the image and visual quality of a second area distinguished from the first area may be different. The wearable device 200 may obtain an image having the visual quality of the first area matching the user's gaze and the visual quality of the second area by using foveated rendering. For example, when the wearable device 200 supports an iris recognition function, user authentication may be performed based on iris information obtained using the eye tracking camera 260-1. An example in which the eye tracking camera 260-1 is disposed toward the user's right eye is illustrated in FIG. 2B, but the embodiment is not limited thereto, and the eye tracking camera 260-1 may be disposed alone toward the user's left eye or may be disposed toward two eyes.

In an embodiment, the photographing camera 260-4 may photograph a real image or background to be matched with a virtual image in order to implement the augmented reality or mixed reality content. The photographing camera 260-4 may be used to obtain an image having a high resolution based on a high resolution (HR) or a photo video (PV). The photographing camera 260-4 may photograph an image of a specific object existing at a position viewed by the user and may provide the image to the at least one display 250. The at least one display 250 may display one image in which a virtual image provided through the at least one optical device 282 and 284 is overlapped with information on the real image or background including an image of the specific object obtained by using the photographing camera 260-4. The wearable device 200 may compensate for depth information (e.g., a distance between the wearable device 200 and an external object obtained through a depth sensor), by using an image obtained through the photographing camera 260-4. The wearable device 200 may perform object recognition through an image obtained using the photographing camera 260-4. The wearable device 200 may perform a function (e.g., auto focus) of focusing an object (or subject) within an image and/or an optical image stabilization (OIS) function (e.g., an anti-shaking function) by using the photographing camera 260-4. While displaying a screen representing a virtual space on the at least one display 250, the wearable device 200 may perform a pass through function for displaying an image obtained through the photographing camera 260-4 overlapping at least a portion of the screen. In an embodiment, the photographing camera 260-4 may be disposed on the bridge 203 disposed between the first rim 201 and the second rim 202.

The eye tracking camera 260-1 may implement a more realistic augmented reality by matching the user's gaze with the visual information provided on the at least one display 250, by tracking the gaze of the user wearing the wearable device 200. For example, when the user looks at the front, the wearable device 200 may naturally display environment information associated with the user's front on the at least one display 250 at a position where the user is positioned. The eye tracking camera 260-1 may be configured to capture an image of the user's pupil in order to determine the user's gaze. For example, the eye tracking camera 260-1 may receive gaze detection light reflected from the user's pupil and may track the user's gaze based on the position and movement of the received gaze detection light. In an embodiment, the eye tracking camera 260-1 may be disposed at a position corresponding to the user's left and right eyes. For example, the eye tracking camera 260-1 may be disposed in the first rim 201 and/or the second rim 202 to face the direction in which the user wearing the wearable device 200 is positioned.

The motion recognition camera 260-2 and 260-3 may provide a specific event to the screen provided on the at least one display 250 by recognizing the movement of the whole or portion of the user's body, such as the user's torso, hand, or face. The motion recognition camera 260-2 and 260-3 may obtain a signal corresponding to motion by recognizing the user's motion (e.g., gesture recognition), and may provide a display corresponding to the signal to the at least one display 250. The processor may identify a signal corresponding to the operation and may perform a preset function based on the identification. The motion recognition camera 260-2 and 260-3 may be used to perform simultaneous localization and mapping (SLAM) for 6 degrees of freedom pose (6 dof pose) and/or a space recognition function using a depth map. The processor may perform a gesture recognition function and/or an object tracking function, by using the motion recognition camera 260-2 and 260-3. In an embodiment, the motion recognition camera 260-2 and camera 260-3 may be disposed on the first rim 201 and/or the second rim 202.

The camera 260 included in the wearable device 200 is not limited to the above-described eye tracking camera 260-1 and the motion recognition camera 260-2 and 260-3. For example, the wearable device 200 may identify an external object included in the FoV by using a camera disposed toward the user's FoV. The wearable device 200 identifying the external object may be performed based on a sensor for identifying a distance between the wearable device 200 and the external object, such as a depth sensor and/or a time of flight (ToF) sensor. The camera 260 disposed toward the FoV may support an autofocus function and/or an optical image stabilization (OIS) function. For example, in order to obtain an image including a face of the user wearing the wearable device 200, the wearable device 200 may include the camera 260 (e.g., a face tracking (FT) camera) disposed toward the face.

Although not illustrated, the wearable device 200 according to an embodiment may further include a light source (e.g., LED) that emits light toward a subject (e.g., user's eyes, face, and/or an external object in the FoV) photographed by using the camera 260. The light source may include an LED having an infrared wavelength. The light source may be disposed on at least one of the frame 200, and the hinge units 206 and 207.

According to an embodiment, the battery module 270 may supply power to electronic components of the wearable device 200. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

The antenna module 275 may transmit the signal or power to the outside of the wearable device 200 or may receive the signal or power from the outside. In an embodiment, the antenna module 275 may be disposed in the first temple 204 and/or the second temple 205. For example, the antenna module 275 may be disposed close to one surface of the first temple 204 and/or the second temple 205.

The speaker 255 may output a sound signal to the outside of the wearable device 200. A sound output module may be referred to as a speaker. In an embodiment, the speaker 255 may be disposed in the first temple 204 and/or the second temple 205 in order to be disposed adjacent to the ear of the user wearing the wearable device 200. For example, the speaker 255 may include a second speaker 255-2 disposed adjacent to the user's left ear by being disposed in the first temple 204, and a first speaker 255-1 disposed adjacent to the user's right ear by being disposed in the second temple 205.

The light emitting module (not illustrated) may include at least one light emitting element. The light emitting module may emit light of a color corresponding to a specific state or may emit light through an operation corresponding to the specific state in order to visually provide information on a specific state of the wearable device 200 to the user. For example, when the wearable device 200 requires charging, it may emit red light at a constant cycle. In an embodiment, the light emitting module may be disposed on the first rim 201 and/or the second rim 202.

Referring to FIG. 2B, according to an embodiment, the wearable device 200 may include the printed circuit board (PCB) 290. The PCB 290 may be included in at least one of the first temple 204 or the second temple 205. The PCB 290 may include an interposer disposed between at least two sub PCBs. On the PCB 290, one or more hardware (e.g., hardware illustrated by different blocks of FIG. 4) included in the wearable device 200 may be disposed. The wearable device 200 may include a flexible PCB (FPCB) for interconnecting the hardware.

According to an embodiment, the wearable device 200 may include at least one of a gyro sensor, a gravity sensor, and/or an acceleration sensor for detecting the posture of the wearable device 200 and/or the posture of a body part (e.g., a head) of the user wearing the wearable device 200. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 200 may identify the user's motion and/or gesture performed to execute or stop a specific function of the wearable device 200 based on the IMU.

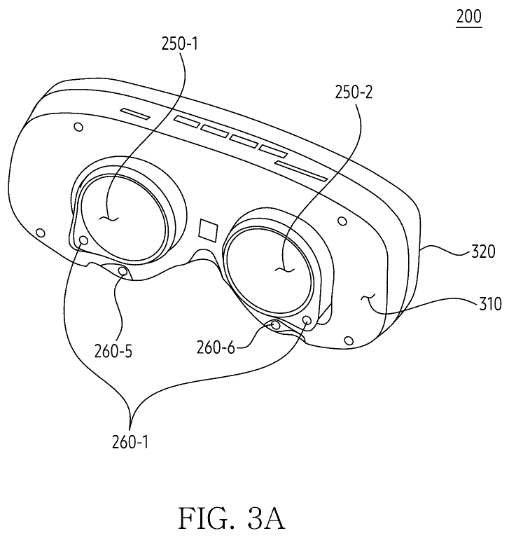

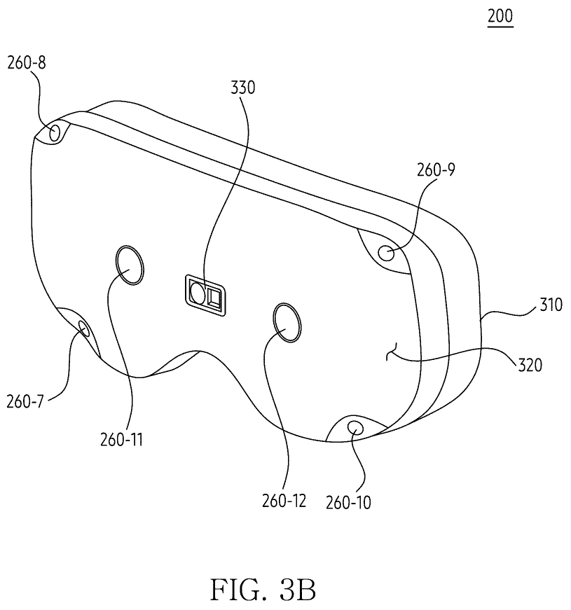

FIGS. 3A and 3B illustrate an example of an exterior of a wearable device according to an embodiment. A wearable device 300 of FIGS. 3A and 3B may be an example of the electronic device 101 of FIG. 1 and the wearable device 200 of FIGS. 2A and 2B. According to an embodiment, an example of an exterior of a first surface 310 of a housing of the wearable device 200 is illustrated in FIG. 3A, and an example of an exterior of a second surface 320 opposite to the first surface 310 may be illustrated in FIG. 3B.

Referring to FIG. 3A, according to an embodiment, the first surface 310 of the wearable device 200 may have an attachable shape on the user's body part (e.g., the user's face). Although not illustrated, the wearable device 200 may further include a strap for being fixed on the user's body part, and/or one or more temples (e.g., the first temple 204 and/or the second temple 205 of FIGS. 2A to 2B). A first display 250-1 for outputting an image to the left eye among the user's two eyes and a second display 250-2 for outputting an image to the right eye among the user's two eyes may be disposed on the first surface 310. The wearable device 200 may further include rubber or silicon packing, which are formed on the first surface 310, for preventing or reducing interference by light (e.g., ambient light) different from the light emitted from the first display 250-1 and the second display 250-2.

According to an embodiment, the wearable device 200 may include camera 260-1 for photographing and/or tracking two eyes of the user adjacent to each of the first display 250-1 and the second display 250-2. The camera 260-1 may be referred to as the gaze tracking camera 260-1 of FIG. 2B. According to an embodiment, the wearable device 200 may include cameras 260-5 and 260-6 for photographing and/or recognizing the user's face. The cameras 260-5 and 260-6 may be referred to as a FT camera. The wearable device 200 may control an avatar representing a user in a virtual space, based on a motion of the user's face identified using the cameras 260-5 and 260-6. For example, the wearable device 200 may change a texture and/or a shape of a portion (e.g., a portion of an avatar representing a human face) of the avatar, by using information obtained by the cameras 260-5 and 260-6 (e.g., the FT camera) and representing the facial expression of the user wearing the wearable device 200.

Referring to FIG. 3B, a camera (e.g., cameras 260-7, 260-8, 260-9, 260-10, 260-11, and 260-12), and/or a sensor (e.g., the depth sensor 330) for obtaining information associated with the external environment of the wearable device 200 may be disposed on the second surface 320 opposite to the first surface 310 of FIG. 3A. For example, the cameras 260-7, 260-8, 260-9, and 260-10 may be disposed on the second surface 320 in order to recognize an external object. The cameras 260-7, 260-8, 260-9, and 260-10 may be referred to as the motion recognition cameras 260-2 and 260-3 of FIG. 2B.

For example, by using cameras 260-11 and 260-12, the wearable device 200 may obtain an image and/or video to be transmitted to each of the user's two eyes. The camera 260-11 may be disposed on the second surface 320 of the wearable device 200 to obtain an image to be displayed through the second display 250-2 corresponding to the right eye among the two eyes. The camera 260-12 may be disposed on the second surface 320 of the wearable device 200 to obtain an image to be displayed through the first display 250-1 corresponding to the left eye among the two eyes. The cameras 260-11 and 260-12 may be referred to as the photographing camera 260-4 of FIG. 2B.

According to an embodiment, the wearable device 200 may include the depth sensor 330 disposed on the second surface 320 in order to identify a distance between the wearable device 200 and the external object. By using the depth sensor 330, the wearable device 200 may obtain spatial information (e.g., a depth map) about at least a portion of the FoV of the user wearing the wearable device 200. Although not illustrated, a microphone for obtaining sound outputted from the external object may be disposed on the second surface 320 of the wearable device 200. The number of microphones may be one or more according to embodiments.

FIG. 4 illustrates an example of a block diagram of a wearable device according to an embodiment. Referring to FIG. 4, a wearable device 200 according to an embodiment may include at least one of a processor 410, memory 415, a display 420, a camera 425, a sensor 430, or communication circuitry 435. The processor 410, the memory 415, the display 420, the camera 425, the sensor 430, and the communication circuitry 435 may be electronically and/or operably coupled with each other by an electronical component such as a communication bus 402. A type and/or the number of hardware components included in the wearable device 200 is not limited to as illustrated in FIG. 4. For example, the wearable device 200 may include only some of the hardware components illustrated in FIG. 4. Elements (e.g., layers and/or modules) in memory described below may be in a state of logically being divided. However, it is not limited thereto.

The processor 410 of the wearable device 200 according to an embodiment may include a hardware component for processing data based on one or more instructions. The hardware component for processing data may include, for example, an arithmetic and logic unit (ALU), a field programmable gate array (FPGA), and/or a central processing unit (CPU). The number of processor 410 may be one or more. For example, the processor 410 may have a structure of a multi-core processor such as a dual core, a quad core, or a hexa core.

The memory 415 of the wearable device 200 according to an embodiment may include a hardware component for storing data and/or instructions inputted to and/or outputted from the processor 410. The memory 415 may include, for example, a volatile memory such as a random-access memory (RAM) and/or a non-volatile memory such as a read-only memory (ROM). The volatile memory may include, for example, at least one of a dynamic RAM (DRAM), a static RAM (SRAM), a Cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, and an embedded multi media card (eMMC).

In an embodiment, the display 420 of the wearable device 200 may output visualized information to a user of the wearable device 200. For example, the display 420 may output visualized information to the user by being controlled by the processor 410 including circuitry such as a graphic processing unit (GPU). The display 420 may include a flat panel display (FPD) and/or electronic paper. The FPD may include a liquid crystal display (LCD), a plasma display panel (PDP), and/or one or more light emitting diodes (LEDs). The LED may include an organic LED (OLED).

In an embodiment, the camera 425 of the wearable device 200 may include one or more optical sensors (e.g., a charged coupled device (CCD) sensor and a complementary metal oxide semiconductor (CMOS) sensor) that generate an electrical signal indicating a color and/or brightness of light. A plurality of optical sensors included in the camera 425 may be disposed in a form of a 2-dimensional array. The camera 425 may generate 2D frame data corresponding to light reaching the optical sensors of the 2D array by obtaining electrical signals of each of the plurality of optical sensors substantially simultaneously. For example, photo data captured using the camera 425 may mean a 2D frame data obtained from the camera 425. For example, video data captured using the camera 425 may mean a sequence of a plurality of 2D frame data obtained from the camera 425 along a frame rate. The camera 425 may further include a flash light that is disposed toward a direction in which the camera 425 receives light and outputs light toward the direction.

The wearable device 200 according to an embodiment may include a plurality of cameras disposed toward different directions as an example of the camera 425. Among the plurality of cameras, a first camera may be referred to as a motion recognition camera (e.g., the motion recognition cameras 260-2 and 260-3 of FIG. 2B), and a second camera may be referred to as a gaze tracking camera (e.g., the gaze tracking camera 260-1 of FIG. 2B). The wearable device 200 may identify a position, a shape, and/or a gesture of a hand by using an image obtained using the first camera. The wearable device 200 may identify a direction of the user's gaze wearing the wearable device 200 by using an image obtained using the second camera. As an example, a direction in which the first camera is directed and a direction in which the second camera is directed may be opposite to each other.

The sensor 430 of the wearable device 200 according to an embodiment may generate electronic information that may be processed by the processor 410 and/or the memory 415 of the wearable device 200 from non-electronic information associated with the wearable device 200. The information may be referred to as sensor data. The sensor 430 may include a global positioning system (GPS) sensor for detecting a geographic location of the wearable device 200, an image sensor, an illumination sensor and/or a time-of-flight (ToF) sensor, and an inertial measurement unit (IMU) for detecting a physical motion of the wearable device 200.

In an embodiment, the communication circuitry 435 of the wearable device 200 may include a hardware component for supporting transmission and/or reception of an electrical signal between the wearable device 200 and an external electronic device. The communication circuitry 435 may include, for example, at least one of a modem (MODEM), an antenna, and an optic/electronic (O/E) converter. The communication circuitry 435 may support transmission and/or reception of an electrical signal based on various types of protocol such as an ethernet, a local area network (LAN), a wide area network (WAN), a wireless fidelity (WiFi), Bluetooth, a bluetooth low energy (BLE), ZigBee, long term evolution (LTE), 5G new radio (NR), and/or 6G.

In the memory 415 of the wearable device 200 according to an embodiment, one or more instructions (or commands) indicating a calculation and/or an operation to be performed by the processor 410 of the wearable device 200 on data may be stored. A set of the one or more instructions may be referred to as firmware, an operating system, a process, a routine, a sub-routine, and/or an application. For example, the wearable device 200 and/or the processor 410 may perform at least one of operations according to an embodiment described below when a set of a plurality of instructions distributed in a form of the operating system, the firmware, a driver, and/or the application is executed. In the following, the application being installed in the wearable device 200 may mean that one or more instructions provided in the form of the application are stored in the memory 415, and that the one or more applications are stored in a format (e.g., a file with an extension designated by the operating system of the wearable device 200) executable by the processor 410. As an example, the application may include a program associated with a service provided to the user and/or a library.

Referring to FIG. 4, programs installed in the wearable device 200 may be classified into any one layer of different layers, including an application layer 440, a framework layer 450, and/or a hardware abstraction layer (HAL) 480 based on a target. For example, programs (e.g., a module or a driver) designed to target hardware (e.g., the display 420, the camera 420, and/or the sensor 430) of the wearable device 200 may be classified in the hardware abstraction layer 480. The framework layer 450 may be referred to as an XR framework layer in that one or more programs for providing an extended reality (XR) service are included. For example, FIG. 4 illustrates layers separately in the memory 415, but the layers may be logically separated. However, it is not limited thereto. According to an embodiment, the layers may also be stored in a designated region in the memory 415.

For example, in the framework layer 450, programs (e.g., a position tracker 471, a space recognizer 472, a gesture tracker 473 and/or a gaze tracker 474, and a face tracker 475) designed to target at least one of the hardware abstraction layer 480 and/or an application layer 440 may be classified. The programs classified into the framework layer 450 may provide an application programming interface (API) that is executable based on another program.

For example, in the application layer 440, programs designed to target the user controlling the wearable device 200 may be classified. As an example of programs classified into the application layer 440, an extended reality (XR) system user interface (UI) and/or an XR application 442 are illustrated, but an embodiment is not limited thereto. For example, the programs (e.g., a software application) classified into the application layer 440 may cause execution of a function supported by the programs classified into the framework layer 450 by calling the application programming interface (API).

For example, based on execution of an XR system UI 441, the wearable device 200 may display one or more visual objects for performing interaction with the user to use a virtual space, on the display 420. A visual object may mean an object that is deployable in a screen for transmission and/or interaction of information, such as a text, an image, an icon, a video, a button, a check box, a radio button, a text box, a slider, and/or a table. A visual object may be referred to as a visual guide, a virtual object, a visual element, a UI element, a view object, and/or a view element. The wearable device 200 may provide a service capable of controlling functions available in the virtual space to the user based on the execution of the XR system UI 441.

Referring to FIG. 4, it is illustrated that a lightweight renderer 443 and/or an XR plug-in 444 are included in the XR system UI 441, but it is not limited thereto. For example, the XR system UI 441 may cause execution of a function supported by the lightweight renderer 443 and/or the XR plug-in 444 included in the framework layer 450.

For example, the wearable device 200 may obtain a resource (e.g., an API, a system process, and/or a library) used to define, generate, and/or execute a rendering pipeline that is allowed for a partial change based on the execution of the lightweight renderer 442. The lightweight renderer 443 may be referred to as a lightweight render pipeline in terms of defining the rendering pipeline, in which the partial change is allowed. The lightweight renderer 443 may include a renderer (e.g., a prebuilt renderer) built before execution of a software application. For example, the wearable device 200 may obtain a resource (e.g., an API, a system process, and/or a library) used to define, generate, and/or execute an entire rendering pipeline based on the execution of the XR plug-in 444. The XR plug-in 444 may be referred to as an open XR native client in terms of defining (or setting) the entire rendering pipeline.

For example, the wearable device 200 may display a screen indicating at least a portion of the virtual space on the display 420 based on execution of the XR application 442. An XR plug-in 444-1 included in the XR application 442 may be referred to the XR plug-in 444 of the XR system UI 441. Among description of the XR plug-in 444-1, description overlapping the description of the XR plug-in 444 may be omitted. The wearable device 200 may cause execution of a virtual space manager 451 based on the execution of the XR application 442.

According to an embodiment, the wearable device 200 may provide a virtual space service based on the execution of the virtual space manager 451. For example, the virtual space manager 451 may include a platform (e.g., an Android platform) for supporting the virtual space service. Based on the execution of the virtual space manager 451, the wearable device 200 may display a posture of a virtual object indicating a posture of the user rendered using data obtained through the sensor 430 on a display. The virtual space manager 451 may be referred to as a composition presentation manager (CPM).

For example, the virtual space manager 451 may include a runtime service 452. As an example, the runtime service 452 may be referred to as an OpenXR runtime module. The wearable device 200 may be used to provide at least one of a pose prediction function of the user, a frame timing function, and/or a space input function through the wearable device 200 based on execution of the runtime service 452. As an example, the wearable device 200 may be used to perform rendering for the virtual space service to the user based on the execution of the runtime service 452. For example, an application (e.g., unity or an OpenXR native application) may be implemented based on the execution of the runtime service 452.

For example, the virtual space manager 451 may include a pass-through manager 453. While displaying a screen indicating a virtual space on the display 420 based on execution of the pass-through manager 453, the wearable device 200 may overlap and display another screen indicating a real space obtained through the camera 425 on at least a portion of the screen.

For example, the virtual space manager 451 may include an input manager 454. The wearable device 200 may identify data (e.g., sensor data) obtained by executing one or more programs included in a perception service layer 470 based on execution of the input manager 454. The wearable device 200 may start executing at least one of the functions of the wearable device 200 by using the obtained data.

For example, a perception abstract layer 460 may be used for data exchange between the virtual space manager 451 and the perception service layer 470. In terms of being used for the data exchange between the virtual space manager 451 and the perception service layer 470, the perception abstract layer 460 may be referred to as an interface. As an example, the perception abstract layer 460 may be referred to as an OpenPX. The perception abstract layer 460 may be used for a perception client and a perception service.

According to an embodiment, the perception service layer 470 may include one or more programs for processing data obtained from the sensor 430 (or the camera 425). The one or more programs may include at least one of the position tracker 471, the space recognizer 472, the gesture tracker 473, the gaze tracker 474, and/or the face tracker 473. A type and/or the number of one or more programs included in the perception service layer 470 is not limited to as illustrated in FIG. 4.

For example, the wearable device 200 may identify a posture of the wearable device 200 using the sensor 430 based on execution of the position tracker 471. Based on the execution of the position tracker 471, the wearable device 200 may identify a 6 degrees of freedom pose (6 dof pose) of the wearable device 200 by using data obtained using the camera 425 and the IMU. The position tracker 471 may be referred to as a head tracking (HeT) module.

For example, the wearable device 200 may be used to configure a surrounding environment of the wearable device 200 (or the user of the wearable device 200) in a 3-dimensional virtual space based on execution of the space recognizer 472. Based on the execution of the space recognizer 472, the wearable device 200 may reconstruct the surrounding environment of the wearable device 200 in 3D by using the data obtained using the camera 425. The wearable device 200 may identify at least one of a plane, an inclination, and a step based on the surrounding environment of the wearable device 200 reconstructed in the 3D based on the execution of the space recognizer 472. The space recognizer 472 may be referred to as a scene understanding (SU) module.

For example, the wearable device 200 may be used to identify (or recognize) a pose and/or a gesture of the hand of the user of the wearable device 200 based on execution of the gesture tracker 473. As an example, the wearable device 200 may identify the pose and/or the gesture of the hand of the user using data obtained from the sensor 430 based on the execution of the gesture tracker 473. As an example, the wearable device 200 may identify the pose and/or the gesture of the hand of the user based on data (or image) obtained using the camera, based on the execution of the gesture tracker 473. The gesture tracker 473 may be referred to as a hand tracking (HaT) module and/or a gesture tracking module.

For example, the wearable device 200 may identify (or track) movement of an eye of the user of the wearable device 200 based on execution of the gaze tracker 474. As an example, the wearable device 200 may identify the movement of the eye of the user by using data obtained from at least one sensor based on the execution of the gaze tracker 474. As an example, the wearable device 200 may identify the movement of the eye of the user based on data obtained using a camera (e.g., the gaze tracking camera 260-1 of FIGS. 2A and 2B) and/or an infrared light emitting diode (IR LED) based on the execution of the gaze tracker 474. The gaze tracker 474 may be referred to as an eye tracking (ET) module and/or a gaze tracking module.

For example, the perception service layer 470 of the wearable device 200 may further include the face tracker 475 for tracking a face of the user. For example, the wearable device 200 may identify (or track) the movement of the face of the user and/or a facial expression of the user based on the execution of the face tracker 475. The wearable device 200 may estimate the facial expression of the user based on the movement of the face of the user based on the execution of the face tracker 475. As an example, the wearable device 200 may identify the movement of the face of the user and/or the facial expression of the user based on data (e.g., an image) obtained using the camera based on the execution of the face tracker 475.

For embodiments to be described below, the wearable device 200 of FIG. 4 may be referred. For example, the embodiments to be described below may be performed by the processor 410 of the wearable device 200 of FIG. 4.

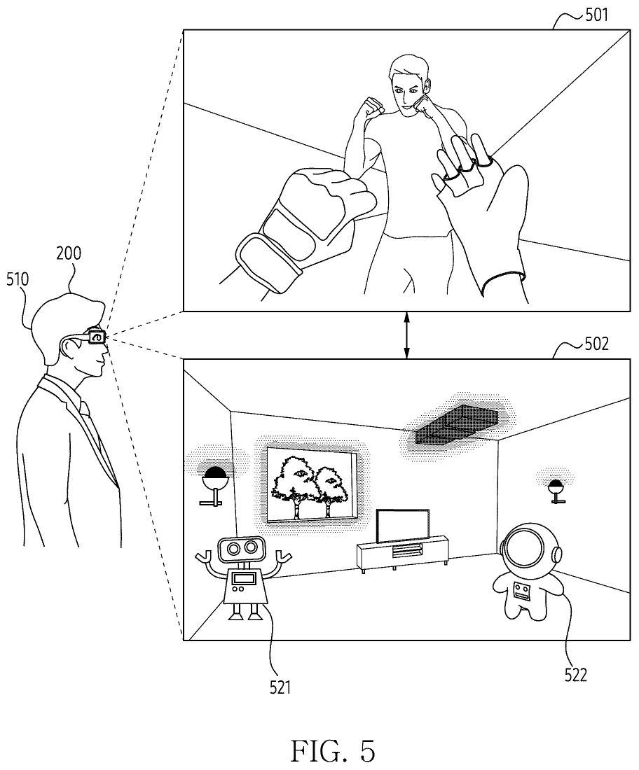

FIG. 5 illustrates an example of virtual spaces changed according to a display mode of a display according to an embodiment.

Referring to FIG. 5, a wearable device 200 may correspond to the wearable device 200 illustrated in FIG. 4. For example, the wearable device 200 may include a camera 425 disposed toward a front of a user 510 in a state of being worn by the user 510. The front of the user 510 may include a direction in which a head of the user 510 and/or a gaze of the user 510 faces. The wearable device 200 according to an embodiment may include a sensor 430 for identifying a motion of the head of the user 510 and/or the wearable device 200 in a state of being worn by the user 510.

A processor 410 of the wearable device 200 may identify an angle of the wearable device 200 based on data of the sensor 430. In order to provide a user interface (UI) based on virtual reality (VR), augmented reality (AR), and/or mixed reality (MR) to the user 510 wearing the wearable device 200, the processor 410 may control the camera 425, and/or the sensor 430. The UI may be related to a metaverse service and/or a notification service provided by the wearable device 200 and/or a server connected to the wearable device 200.

According to an embodiment, the processor 410 may identify a display mode of a display 420 as one of a first display mode and a second display mode. For example, the processor 410 may display a first virtual space 501 (or a portion of the first virtual space 501) through the display 420 based on the first display mode. The processor 410 may display a second virtual space 502 (or a portion of the second virtual space 502) through the display 420 based on the second display mode.

As an example, the first virtual space 501 according to the first display mode may be configured to be distinct from a space (e.g., a real space) where the user 510 is located. The second virtual space 502 according to the second display mode may be configured to include the space (e.g., the real space) where the user 510 is located and one or more visual objects displayed overlappingly in the space.

According to an embodiment, the first display mode may include a mode for displaying (or providing) a virtual space (e.g., the virtual space 501) related to virtual reality (VR). For example, the wearable device 200 may include the display 420 disposed on a first surface (e.g., the first surface 310 of FIG. 3A) facing an eye of the user 510. The wearable device 200 may include the camera 425 (or the cameras 260-7, 260-8, 260-9, 260-10, 260-11, and 260-12 of FIG. 3B) disposed on a second surface (e.g., the second surface 320 of FIG. 3A) opposite the first surface. Using the camera 425, the processor 410 may obtain frame images including ambient light. The processor 410 may output the frame images to the display 420 disposed on the first surface so that the user 510 recognizes ambient light through the display 420. A display area of the display 420 disposed on the first surface may be formed by one or more pixels included in the display 420. The processor 410 may synthesize the virtual object in the frame images outputted through the display 420 to allow the user 510 to recognize the virtual object together with a real object recognized by ambient light.

According to an embodiment, the second display mode may include a mode for displaying (or providing) a virtual space (e.g., the virtual space 502) related to augmented reality (AR) and/or mixed reality (MR). In a state in which the user 510 wears the wearable device 200, the processor 410 may include at least one lens disposed adjacent to an eye of the user 510. Ambient light passing through the lens may be combined (or mixed) with light emitted from the display 420 of the wearable device 200. The display area of the display 420 may be formed in the lens through which the ambient light passes. Since the processor 410 combines the ambient light and the light emitted from the display 420, the user 510 may view an image in which the real object recognized by the ambient light and a virtual object formed by the light emitted from the display 420 are mixed.

According to an embodiment, the processor 410 may provide a user experience based on mixed reality (MR) while the display mode of the display 420 is set to one of the first display mode and the second display mode. The processor 410 of the wearable device 200 may recognize a space (e.g., a real space) where the user 510 (or the wearable device 200) is located, and generate a virtual space mapped to the space. Spatial recognition performed by the processor 410 may include simultaneous localization and mapping (SLAM) and/or spatial mapping (e.g., scene understanding).

According to an embodiment, the wearable device 200 may operate based on a video seethrough (VST). For example, the processor 410 may display the virtual space 501 provided to the user 510 based on a video (or a rendered image). For example, while the display mode of the display 420 is the first display mode, the processor 410 may generate the virtual space 501 and display the generated virtual space 501 through the display 420. As an example, the virtual space 501 may be configured based on external environment. The processor 410 may configure a virtual space 501 indicating the external environment and display an additional virtual visual object in the virtual space 501. For example, while the display mode of the display 420 is the second display mode, the processor 410 may obtain an image of the external environment using the camera 425. The processor 410 may display the virtual space 502 including the image of the external environment and visual objects (e.g., a visual object 521 and a visual object 522) overlapping the image through the display 420. The visual objects overlapping the image of the external environment may be variously set. For example, the visual object may be configured with multimedia content (e.g., a video).

According to an embodiment, the wearable device 200 may operate based on an optical seethrough (OST). For example, while the display mode of the display 420 is the first display mode, the processor 410 may display a specified color (or a specified image) through the display 420 so as not to display a space where the wearable device 200 is located. The processor 410 may display the virtual space 501 including a visual object overlapping the specified color (or the specified image). For example, while the display mode of the display 420 is the second display mode, the processor 410 may display the virtual space 502 including an image in which a real object and a virtual object are mixed through the display 420.

According to an embodiment, in a case that the display mode of the display 420 is changed from the first display mode to the second display mode, a change in brightness recognized by the user 510 may occur by a change in brightness of a screen displayed through the display 420 and/or brightness of the external environment. According to an embodiment, in a case that the display mode of the display 420 is changed from the second display mode to the first display mode, the change in brightness recognized by the user 510 may occur by brightness (or a brightness value) set in the first display mode. Accordingly, according to the change in brightness recognized by the user 510, the user 510 may not identify content (e.g., a visual object) displayed through the display 420. For example, the user 510 may not identify the content displayed through the display 420 during light adaptation or dark adaptation. In the following specification, an operation of the wearable device 200 (or the processor 410 of the wearable device 200) for solving a problem in which the user 510 may not identify content according to a change of the display mode of the display 420 will be described.

For example, as the display mode of the display 420 changes from the first display mode to the second display mode, the wearable device 200 may display a changed screen in the second display mode based on a difference in illumination between a screen displayed in the first display mode and a screen displayed in the second display mode being outside a specified range.

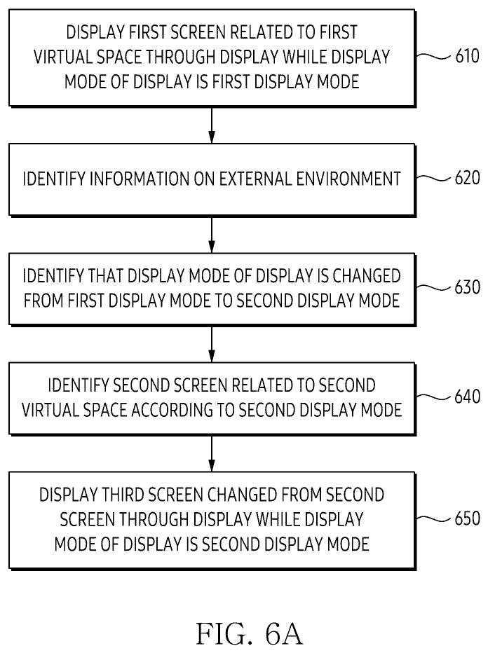

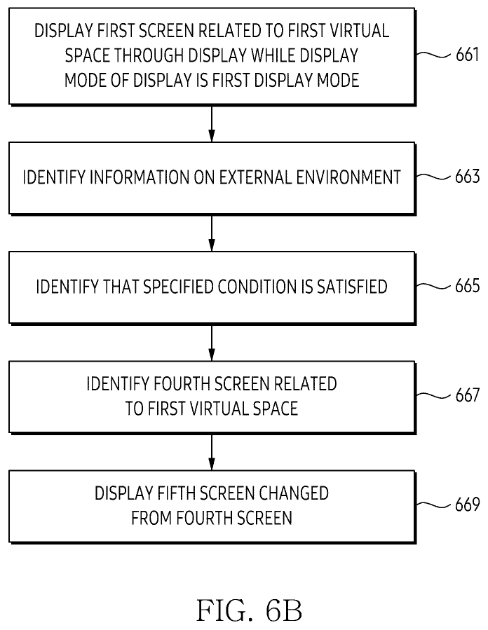

FIG. 6A is a flowchart of an operation of a wearable device according to an embodiment. In the following embodiment, each of operations may be sequentially performed, but is not necessarily performed sequentially. For example, an order of each of the operations may be changed, and at least two operations may be performed in parallel.

Referring to FIG. 6A, in operation 610, a processor 410 may display a first screen related to a first virtual space through a display 420 while a display mode of the display 420 is a first display mode. For example, the processor 410 may set the display mode of the display 420 to the first display mode. For example, the first display mode may be set based on VR.

According to an embodiment, since a virtual space is configured as three dimensions, the processor 410 may not display the entire virtual space through the display 420. Accordingly, the processor 410 may display the virtual space through the display 420 based on displaying a screen related to the virtual space through the display 420. For example, the processor 410 may display the first screen related to the first virtual space through the display 420. As an example, the processor 410 may display the first screen related to the first virtual space based on VR.

In operation 620, the processor 410 may identify information on external environment. For example, the processor 410 may identify the information on the external environment in which the wearable device 200 is located while at least one screen including the first screen related to the first virtual space is displayed.

According to an embodiment, the processor 410 may display the at least one screen including the first screen related to the first virtual space.

For example, the processor 410 may change the first screen related to the first virtual space to another screen based on a motion of the wearable device 200. The processor 410 may display at least one screen based on a change in the motion of the wearable device 200. The at least one screen may mean screens that are continuously changed based on the change in the motion of the wearable device 200.

For example, the processor 410 may change the first screen related to the first virtual space to another screen based on an application executed in the wearable device 200 and/or a service provided in the wearable device 200. The processor 410 may display at least one screen based on at least one of the application executed in the wearable device 200 and/or the service provided in the wearable device 200. The at least one screen may mean screens that are continuously changed based on at least one of the application executed in the wearable device 200 and/or the service provided in the wearable device 200.

For example, the processor 410 may change the first screen related to the first virtual space to another screen based on a signal identified by the wearable device 200. As an example, the signal may be identified by a user input. As an example, the signal may be received from another device. The processor 410 may display at least one screen based on the signal identified by the wearable device 200. The at least one screen may mean screens that are continuously changed based on the signal identified by the wearable device 200.

According to an embodiment, the processor 410 may identify the information on the external environment in which the wearable device 200 is located. For example, the information on the external environment may include information on a position where a light source is disposed within a space where the wearable device 200 (or a user 510) is located. For example, the information on the external environment may include information on a position where at least one light source is disposed within the space where the wearable device 200 is located. An operation of the processor 410 for identifying the information on the position where the at least one light source is disposed within the space where the wearable device 200 is located will be described in 7A.

For example, the information on the external environment may include information on movement of the light source (e.g., information on a direction of the movement and information on speed of the movement). For example, the information on the external environment may include information on a position where a light source having a specified brightness value or more is disposed. For example, the information on the external environment may include information on a position of the brightest light source among the at least one light source within the space where the wearable device 200 is located. For example, the information on the external environment may include information on the number of the at least one light source within the space where the wearable device 200 is located. For example, the information on the external environment may include illuminance information on the external environment.

In operation 630, the processor 410 may identify that the display mode of the display 420 is changed from the first display mode to a second display mode. For example, after the information on the external environment is identified, the processor 410 may identify that the display mode of the display 420 is changed from the first display mode to the second display mode.

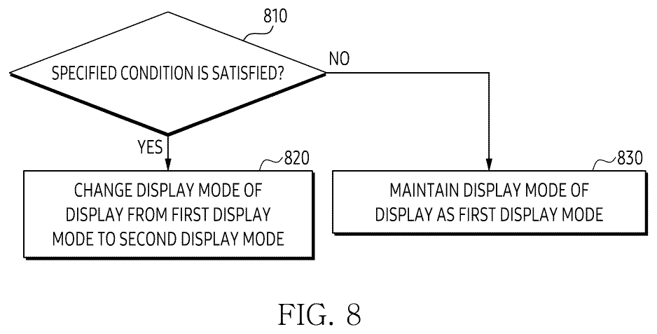

According to an embodiment, the processor 410 may change the display mode of the display 420 from the first display mode to the second display mode based on satisfying a specified condition. For example, the processor 410 may identify whether the specified condition is satisfied based on a specified input, a size of a motion of the wearable device 200, a position of the wearable device 200, and/or a direction in which the wearable device 200 faces. An example of a specific operation for identifying whether the processor 410 satisfies the specified condition will be described in detail in FIG. 8.

In operation 640, the processor 410 may identify a second screen related to a second virtual space according to the second display mode. For example, based on identifying that the display mode of the display 420 changes from the first display mode to the second display mode, the second screen related to the second virtual space according to the second display mode may be identified. For example, the processor 410 may identify the second screen related to the second virtual space based on the display mode of the display 420 being the second display mode. For example, the processor 410 may first identify the second screen, which is a screen to be displayed through the display 420.

According to an embodiment, the second screen may be a screen to be recognized by the user. For example, a difference between a brightness (or illuminance recognized by the user) value of the second screen identified according to the second display mode and a brightness (or illuminance recognized by the user) value of a currently displayed screen may be greater than or equal to a specified value. In a case that the second screen is displayed through the display 420, inconvenience may occur to the user 510. For example, the processor 410 may identify a difference between a brightness value of an area related to a gaze of the user in the currently displayed screen and a brightness value of an area related to a gaze of the user in the second screen. In a case that the difference between the brightness values is greater than or equal to the specified value, inconvenience may occur to the user 510.

According to an embodiment, in a case that the difference between the brightness value of the area related to the gaze of the user in the currently displayed screen and the brightness value of the area related to the gaze of the user in the second screen is less than the specified value, inconvenience may not occur to the user 510. Accordingly, the processor 410 may display the second screen through the display 420 without performing operation 650. For example, the processor 410 may identify that a change in brightness of the area related to the gaze of the user is within a brightness adaptable range of the user. The processor 410 may display the second screen through the display 420 without performing the operation 650. For example, the processor 410 may identify that the change in brightness of the area related to the gaze of the user is outside the brightness adaptable range of the user. The processor 410 may perform the operation 650. For example, the brightness adaptable range of the user may be identified through a specified model (e.g., an artificial intelligence model) indicated by a plurality of parameters. The processor 410 may train the specified model based on at least one of a position of the user, a time of using the wearable device 200, an application executed in the wearable device 200, and a service provided through the wearable device 200. The processor 410 may identify the brightness adaptable range of the user based on the specified model. As an example, even when the user of the wearable device 200 is the same, the processor 410 may change the brightness adaptable range of the user according to an application being currently executed (or provided service). For example, the processor 410 may set a brightness adaptable range of the user while providing a first service (e.g., a game service) and a brightness adaptable range of the user while providing a second service (e.g., a service displaying a virtual object in real environment) differently from each other.

According to an embodiment, the processor 410 may track (or monitor) a gaze (or an ROI) of the user. The processor 410 may identify a gaze direction and an angle of view of the user based on a change in the gaze of the user. The processor 410 may identify whether a light source is located in a field of view of the user based on the gaze direction and the angle of view of the user. The processor 410 may identify whether a change in brightness of an area related to the changed gaze of the user is within the brightness adaptable range of the user.

In the operation 650, the processor 410 may display a third screen changed from the second screen through the display 420 while the display mode of the display 420 is the second display mode. For example, based on the information on the external environment and a first area in the second screen identified according to a gaze of the user 510 of the wearable device 200, the processor 410 may display the third screen changed from the second screen through the display 420 while the display mode of the display 420 is the second display mode.

According to an embodiment, the processor 410 may identify the gaze of the user 510 of the wearable device 200. The processor 410 may identify the first area within the second screen according to the gaze of the user 510. The processor 410 may identify the first area in the second screen to be displayed through the display 420 based on the gaze of the user 510.

According to an embodiment, the processor 410 may identify whether the first area in the second screen identified according to the gaze of the user 510 corresponds to a second area in the second screen related to a position where a light source is disposed. For example, the second area may be related to a position where one light source among at least one light source is disposed. For example, the second area may include an area where the brightest light source is located among at least one light source (or a plurality of light sources) of the external environment. For example, the second area may include an area in which a light source is finally identified according to movement of the light source.

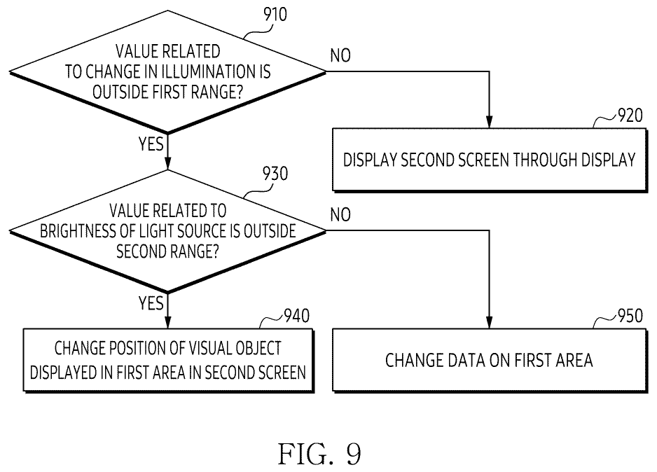

For example, the processor 410 may identify that the first area corresponds to the second area. Based on identifying that the first area corresponds to the second area, the processor 410 may display the third screen changed from the second screen through the display 420 while the display mode of the display 420 is the second display mode. A specific example in which the processor 410 displays the third screen changed from the second screen will be described with reference to FIG. 9.

For example, the processor 410 may identify that the first area is distinct from the second area. Based on identifying that the first area is distinct from the second area, the processor 410 may display the second screen through the display 420.

According to an embodiment, the processor 410 may identify that the gaze of the user 510 is located in the second area in the second screen corresponding to an external light source based on a change of the display mode of the display 420 from the first display mode to the second display mode. The processor 410 may display the third screen changed from the second screen through the display 420 so that the user 510 does not perceive a change in brightness equal to or greater than the specified value.

For example, the processor 410 may display the third screen changed from the second screen through the display 420 based on changing a position of a visual object displayed in the first area (or the second area) of the second screen.

For example, the processor 410 may change data related to the first area (or the second area) of the second screen. As an example, the processor 410 may change data on brightness of the first area. The processor 410 may reduce the brightness of the first area based on changing the data on the brightness of the first area. As an example, the processor 410 may overlay a gray scale image on the first area. The processor 410 may reduce brightness of the first area recognized by the user 510 based on overlaying the gray scale image on the first area. As an example, the processor 410 may reduce the brightness of the first area based on overlaying the gray scale image on the first area. The processor 410 may reduce the brightness of the first area within the brightness adaptable range of the user based on overlaying the gray scale image on the first area.

According to an embodiment, while the display mode of the display 420 is the second display mode, the processor 410 may provide a virtual external space 720 where a plurality of virtual visual objects are displayed together in real external environment. The processor 410 may overlay a gray scale image to change brightness of each of the plurality of virtual visual objects. The processor 410 may overlay the gray scale image based on a distance between each of the plurality of virtual visual objects and a light source (or at least one light source). The gray scale image may be changed based on a distance between a virtual visual object and a light source. Accordingly, the gray scale image overlaid on each of the plurality of virtual visual objects may not be the same. According to an embodiment, the processor 410 may overlay the gray scale image only on at least one visual object among the plurality of virtual visual objects.

According to an embodiment, the processor 410 may identify whether a visual object (or content) to be displayed is affected by a light source. For example, in a case that the visual object to be displayed is not affected by the light source, the processor 410 may change only brightness and/or a color of the visual object and display it. For example, in a case that the display mode of the display 420 in the wearable device 200 operating based on a VST is the first display mode, the visual object (or the content) to be displayed may not be affected by the light source. The processor 410 may display the third screen by changing only brightness and/or a color of the visual object included in the second screen. According to an embodiment, the processor 410 may change not only the brightness and/or the color of the visual object, but also a size of the visual object and/or a time at which display of the visual object is maintained.

In the operation 610 to the operation 650, an example in which the first display mode is set based on VR and the second display mode is set based on AR has been described, but is not limited thereto. According to an embodiment, the first display mode may be set based on AR, and the second display mode may be set based on VR.

FIG. 6B is a flowchart of an operation of a wearable device according to an embodiment. In the following embodiment, each of operations may be sequentially performed, but is not necessarily performed sequentially. For example, an order of each of the operations may be changed, and at least two operations may be performed in parallel.

Referring to FIG. 6B, the operation 610 to the operation 650 of FIG. 6A are related to an operation of changing a second screen related to a second virtual space to a third screen and displaying the third screen in a case that a display mode of a display 420 is changed, but operation 661 to operation 669 of FIG. 6B may be related to an operation of changing a fourth screen related to a first virtual space to a fifth screen and displaying the fifth screen in a case that the display mode of the display 420 is not changed.

In the operation 661, a processor 410 may display a first screen related to the first virtual space through the display 420 while the display mode of the display 420 is a first display mode. For example, the operation 661 may correspond to the operation 610 of FIG. 6A.

In operation 663, the processor 410 may identify information on external environment. For example, the operation 663 may correspond to the operation 620 of FIG. 6A.

In operation 665, the processor 410 may identify whether a specified condition is satisfied. For example, in a case that a sudden change of a screen displayed through the display 420 occurs, the specified condition may be satisfied.

For example, the specified condition may be set to whether a value related to a motion of the wearable device 200 exceeds a specified value. The processor 410 may identify the value related to the motion of the wearable device 200. As an example, within a specified time of the wearable device 200, the greater the motion of the wearable device 200, the greater the value related to the motion of the wearable device 200 may be identified. The processor 410 may identify whether the specified condition is satisfied based on identifying whether the value related to the motion of the wearable device 200 exceeds the specified value.

For example, the specified condition may be set to whether a position of the wearable device 200 is outside a specified range. For example, the wearable device 200 may provide a service in a state of being located within the specified range. The processor 410 may identify whether the specified condition is satisfied based on identifying whether the position of the wearable device 200 is outside the specified range.

For example, the specified condition may be set to whether a change in illuminance of the external environment exceeds a threshold range. For example, the processor 410 may identify whether the specified condition is satisfied based on identifying whether the change in illuminance of the external environment exceeds the threshold range.

The above-described specified condition may be set equal to or similar to a condition for changing the display mode of the display 420 from the first display mode to a second display mode.

In operation 667, the processor 410 may identify the fourth screen related to the first virtual space according to the first display mode. For example, the processor 410 may identify the fourth screen to be displayed through the display 420 while the display mode of the display 420 is maintained in the first display mode. For example, the processor 410 may first identify the fourth screen, which is a screen to be displayed through the display 420. For example, a difference between a brightness value of the fourth screen and a brightness value of a currently displayed screen may be greater than or equal to a specified value. In a case that the fourth screen is displayed through the display 420, inconvenience may occur to a user 510. For example, an operation in which the processor 410 identifies the fourth screen related to the first virtual space may correspond to an operation in which the processor 410 identifies the second screen related to the second virtual space in the operation 640 of FIG. 6A.

In the operation 669, the processor 410 may display the fifth screen changed from the fourth screen. For example, based on the information on the external environment and a first area in the fourth screen identified according to a gaze of the user 510 of the wearable device 200, the processor 410 may display the fifth screen changed from the fourth screen through the display 420 while the display mode of the display 420 is the first display mode. For example, an operation in which the processor 410 changes the fourth screen to the fifth screen may correspond to an operation in which the processor 410 changes the second screen to the third screen in the operation 650 of FIG. 6A.

Referring to the operation 661 to the operation 669, the processor 410 may identify that the value related to the motion of the wearable device 200 exceeds the specified value while the display mode of the display 420 is the first display mode. Based on identifying that the value related to the motion of the wearable device 200 exceeds the specified value, the processor 410 may change the fourth screen to be displayed through the display 420 to the fifth screen and display it.

According to an embodiment, in a case that an operation for changing a screen is repeatedly performed even when the specified condition is satisfied, the processor 410 may not perform the operation for changing the screen. For example, based on identifying that the number of times an operation for changing the screen is performed in a reference time is greater than or equal to a specified number of times, the processor 410 may not perform the operation for changing the screen.

For example, even when identifying that the value related to the motion of the wearable device 200 exceeds the specified value, the processor 410 may not change the fourth screen to be displayed through the display 420 to the fifth screen. For example, based on the value related to the motion of the wearable device 200 being maintained in a state exceeding the specified value, the processor 410 may not change the fourth screen to be displayed through the display 420 to the fifth screen. After the value related to the motion is maintained in the state exceeding the specified value, the processor 410 may change the fourth screen to be displayed through the display 420 to the fifth screen, based on identifying that the value related to the motion is changed to less than or equal to the specified value.

According to an embodiment, the processor 410 may identify whether an amount of a change in illuminance is outside a brightness adaptation range. The processor 410 may change brightness of all virtual visual objects displayed in the fourth screen based on whether the amount of the change in illuminance is out of the brightness adaptation range. According to an embodiment, the processor 410 may identify whether it is necessary to change brightness in a partial area in the fourth screen. The processor 410 may change the fourth screen to the fifth screen by changing only the brightness of the partial area in the fourth screen based on a position of a light source. According to an embodiment, an operation in which the processor 410 changes only the brightness of the partial area in the fourth screen may be performed differently according to the number of light sources, brightness of the light sources, and/or a gaze of the user.

In the operation 661 to the operation 669, an example in which the first display mode is set based on VR and the second display mode is set based on AR has been described, but it is not limited thereto. According to an embodiment, the first display mode may be set based on AR, and the second display mode may be set based on VR.

Referring to the operation 661 to the operation 669 described above, even when the display mode of the display 420 is not changed, the processor 410 may change a screen to be displayed based on satisfying the specified condition.

For convenience of description, in the following specification, embodiments for changing a screen to be displayed according to an operation of FIG. 6A may be described. However, this is for convenience of description, and embodiments to be described below may also be applied to an embodiment of changing a screen according to an operation of FIG. 6B.

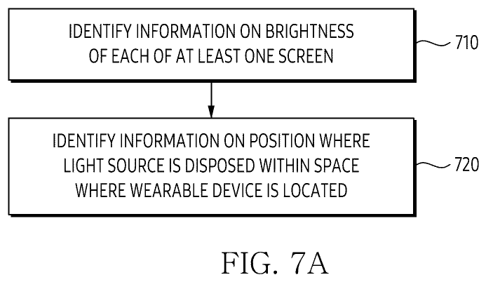

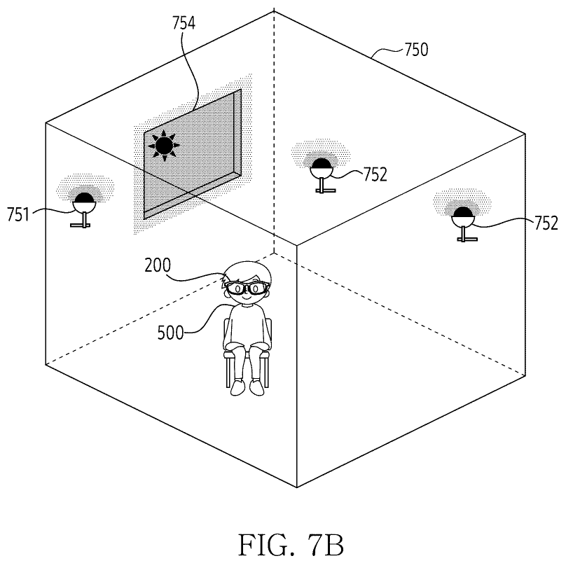

FIG. 7A is a flowchart of an operation of a wearable device according to an embodiment. In the following embodiment, each of operations may be sequentially performed, but is not necessarily performed sequentially. For example, an order of each of the operations may be changed, and at least two operations may be performed in parallel. Operation 710 and operation 720 illustrated in FIG. 7A may correspond to the operation 620 of FIG. 6A.

Referring to FIG. 7A, in the operation 710, a processor 410 may identify information on brightness of each of at least one screen. For example, while a display mode of a display 420 is a first display mode, the processor 410 may display a first screen related to a first virtual space through the display 420. The processor 410 may display at least one screen including the first screen related to the first virtual space. For example, the at least one screen may mean screens that are continuously changed based on a change in a motion of a wearable device 200.

According to an embodiment, while the display mode of the display 420 is a second display mode, external environment may be displayed through at least one screen. The at least one screen may be related to the external environment. In a case that the at least one screen is related to the external environment, the processor 410 may obtain one or more images of the external environment through a camera 425 to display the at least one screen. The processor 410 may obtain information on an exposure value and/or brightness based on the images of the external environment. For example, the processor 410 may obtain information on brightness according to a position of the external environment based on the images of the external environment. The processor 410 may identify brightness changed according to the position of the external environment.

According to an embodiment, while the display mode of the display 420 is the first display mode, a virtual space distinct from the external environment may be displayed through at least one screen. The at least one screen may not be related to the external environment. In a case that the at least one screen is not related to the external environment, the processor 410 may obtain information on the external environment while the at least one screen is displayed. The processor 410 may obtain one or more images of the external environment to obtain the information on the external environment. The processor 410 may obtain information on an exposure value and/or brightness based on the one or more images of the external environment.

According to an embodiment, the processor 410 may obtain one or more images of the external environment based on a gaze of a user 510. For example, the processor 410 may obtain the one or more images of the external environment based on a change in the gaze of the user 510.

In the operation 720, the processor 410 may identify information on a position where a light source is disposed within a space where the wearable device 200 is located. For example, the processor 410 may identify the information on the external environment including the information on the position where the light source is disposed within the space where the wearable device 200 is located.

According to an embodiment, the processor 410 may configure the external environment as a three-dimensional virtual space. For example, the processor 410 may identify a position where a light source is disposed within the external environment configured as the three-dimensional virtual space. As an example, one or more light sources may exist in the external environment. The processor 410 may identify a position where the one or more light sources are disposed within the external environment configured as the three-dimensional virtual space.

For example, the processor 410 may identify information on brightness of the one or more images of the external environment obtained through the camera 425. The processor 410 may identify the information on the position where the light source is disposed within the space where the wearable device 200 is located, based on the information on the brightness of the one or more images of the external environment. As an example, the processor 410 may identify that the light source has been disposed based on identifying that a value related to the brightness in the one or more images is greater than or equal to a reference value. The processor 410 may identify brightness as well as the position where the light source is disposed within the space where the wearable device 200 is located.

According to an embodiment, the processor 410 may identify information on brightness distribution of the external environment and/or information on a maximum brightness based on information on the external environment. For example, one or more images of the external environment may be obtained based on an exposure value set by the camera 425. Based on the exposure value, the processor 410 may identify information (e.g., the information on the brightness distribution of the external environment and the information on the maximum brightness) on actual brightness of the external environment through the one or more images. As an example, brightness of the external environment may be identified as brightness in an image, based on the exposure value set by the camera 425. The processor 410 may obtain a preview image. The processor 410 may identify the information on the actual brightness of the external environment based on identifying brightness of the preview image and an exposure value set for obtaining the preview image. The processor 410 may obtain a plurality of images (or videos). The processor 410 may identify the information on the actual brightness of the external environment based on identifying brightness information (e.g., brightness values) according to the obtained plurality of images and an exposure value set for obtaining the plurality of images.

Accordingly, the processor 410 may identify (or estimate) the information on the actual brightness of the external environment based on information on the brightness of the one or more images and the exposure value set by the camera 425.

According to an embodiment, the processor 410 may obtain a distribution image of a brightness value (e.g., an absolute value of brightness) of the external environment based on the information on the external environment. The distribution image of the brightness value of the external environment may mean an image indicating absolute values of the brightness of the external environment in a three-dimensional space. According to an embodiment, the distribution image of the brightness value of the external environment may be configured to indicate an absolute value of brightness of one point (or area) in an image (or the external environment).

According to an embodiment, the processor 410 may obtain information on a brightness value recognized by the user 510 based on the distribution image of the brightness value of the external environment. In a case that a screen is outputted through the display 420 based on the distribution image of the brightness value of the external environment, the processor 410 may obtain the information on the brightness value recognized by the user 510. For example, the processor 410 may change the brightness value recognized by the user 510 based on a size of a pupil of the user 510.

For example, the processor 410 may identify the information on the size of the pupil through the camera 425 (e.g., a camera facing an eye of the user 510). Based on information on the size of the pupil and information on brightness of the screen to be outputted through the display 420, the processor 410 may obtain information on brightness recognized by the user 510. For example, in the wearable device 200 based on an OST, in a case that the display mode of the display 420 operates in the second display mode (e.g., a display mode based on AR), external light according to the external environment and light emitted through the display 420 of the wearable device 200 may be identified through the eye of the user 510. The size of the pupil of the user 510 may be changed according to the external light and the light emitted through the display 420. The processor 410 may identify that a dark screen is being provided to the user 510 based on identifying that the size of the pupil of the user 510 is greater than or equal to a specified size. The processor 410 may identify that a bright screen is being provided to the user 510 based on identifying that the size of the pupil of the user 510 is less than the specified size. According to an embodiment, the processor 410 may change the brightness value recognized by the user 510 based on the size of the pupil of the user 510. For example, the processor 410 may change the brightness value recognized by the user 510 by changing an amount of light provided through the display 420 based on the size of the pupil of the user 510.

According to an embodiment, the processor 410 may train a specified model (e.g., an artificial intelligence model) indicated by a plurality of parameters based on the information on the pupil size of the user 510. The processor 410 may set a size of the pupil for changing the brightness value recognized by the user 510 based on the specified model. For example, the processor 410 may identify a preference (e.g., a priority) of the user 510 based on a type of a service provided through the wearable device 200 and/or a type of an application executed in the wearable device 200. The processor 410 may set the preference of the user 510 as an input value of the specified model. The processor 410 may identify the size of the pupil for changing the brightness value recognized by the user 510 based on an output value of the specified model.

According to an embodiment, the processor 410 may set at least one of the preference of the user 510 and/or a brightness adaptable range of the user as an input value of the specified model. The processor 410 may identify the size of the pupil for changing the brightness value recognized by the user 510 based on the output value of the specified model.

According to an embodiment, the processor 410 may identify information on a screen to be displayed through the display 420. For example, the processor 410 may identify at least one visual object to be displayed on the screen based on an application being currently executed. The processor 410 may identify the screen on which the at least one visual object is displayed. The processor 410 may identify the screen on which the at least one visual object is displayed based on an operation mode (e.g., a VST and the OST) of the wearable device 200 and the display mode (e.g., the first display mode and the second display mode) of the display 420. Based on the information on the screen to be displayed through the display 420, the processor 410 may identify a screen to be recognized by the user 510.

For example, in the wearable device 200 operating based on the VST, in a case that the display mode of the display 420 is set to the first display mode (e.g., a display mode of the display 420 based on VR), the processor 410 may display a screen related to a generated virtual space regardless of the external environment. The processor 410 may identify that the screen displayed through the display 420 is the screen to be recognized by the user 510. For example, the processor 410 may track (or monitor) a gaze (or an ROI) of the user. The processor 410 may identify that the screen displayed through the display 420 is the screen to be recognized by the user 510 based on a gaze direction and an angle of view of the user.

For example, in the wearable device 200 operating based on the VST, in a case that the display mode of the display 420 is set to the second display mode (e.g., a display mode of the display 420 based on AR), the processor 410 may identify a screen in which at least one visual object is displayed (e.g., overlaid) on a screen related to the external environment obtained using the camera 425 exposed to the outside of the wearable device 200. According to an embodiment, the screen related to the external environment may be obtained based on illuminance information obtained through an illuminance sensor included in a sensor 430 and/or information on the external environment received from an external electronic device as well as the camera 425 exposed to the outside.

The processor 410 may identify the screen in which the at least one visual object is displayed (e.g., overlaid) on the screen related to the external environment as the screen to be displayed through the display 420. The processor 410 may identify that the screen in which the at least one visual object is displayed on the screen related to the external environment is the screen to be recognized by the user 510.

For example, in the wearable device 200 operating based on the OST, in a case that the display mode of the display 420 is set to the first display mode, the processor 410 may identify a screen in which a virtual background to cover the external environment and at least one visual object disposed on the virtual background are displayed as a screen to be displayed through the display 420. The processor 410 may identify the screen in which the virtual background and the at least one visual object are displayed as the screen to be recognized by the user.

For example, in the wearable device 200 operating based on the OST, in a case that the display mode of the display 420 is set to the second display mode, the processor 410 may be configured so that the external environment may be viewed as it is by the user 510. The processor 410 may identify a screen for displaying a visual object displayed overlappingly in the external environment as a screen to be displayed through the display 420. The processor 410 may identify a screen in which at least one visual object is displayed in the external environment as a screen to be recognized by the user 510. According to the above-described embodiment, the processor 410 may identify the screen to be recognized by the user 510 and store the screen to be recognized by the user 510 in memory 415.

According to an embodiment, the processor 410 may identify in advance a screen to be displayed in a case that the display mode of the display 420 is changed from the first display mode to the second display mode. In response to identifying that the display mode of the display 420 is changed from the first display mode to the second display mode, the processor 410 may display the screen identified in advance.

According to an embodiment, the processor 410 may repeatedly perform the above-described operations (e.g., the operation 710 and the operation 720). For example, based on a specified period, the processor 410 may identify in advance the screen to be displayed in a case that the display mode of the display 420 is changed from the first display mode to the second display mode. For example, based on a value related to the motion of the wearable device 200 exceeds a specified value, the processor 410 may identify in advance the screen to be displayed in a case that the display mode of the display 420 is changed from the first display mode to the second display mode. For example, based on a change in illuminance of the external environment exceeding a threshold range, the processor 410 may identify in advance the screen to be displayed in a case that the display mode of the display 420 is changed from the first display mode to the second display mode.

According to an embodiment, the processor 410 may identify the screen to be displayed through the display 420 as the second screen described in FIG. 6A. The processor 410 may compare the screen to be recognized by the user 510 and the screen (or the second screen) to be displayed in a case that the display mode of the display 420 is changed from the first display mode to the second display mode. Based on comparing the screen to be recognized by the user 510 and the screen (or the second screen) to be displayed in a case that the display mode of the display 420 is changed from the first display mode to the second display mode, the processor 410 may identify that a difference in brightness (or a difference in illuminance recognized by the user 510) in an area corresponding to the gaze of the user 510 occurs. The processor 410 may perform an operation for changing the second screen to a third screen.

FIG. 7B illustrates an example of an operation of identifying a position where a light source is disposed within a space where a wearable device is located, according to an embodiment.

Referring to FIG. 7B, a processor 410 may identify one or more images of an external environment. For example, the processor 410 may obtain the one or more images of the external environment through a camera 425 (e.g., a camera facing the external environment). Based on identifying an area in which a value related to brightness is greater than or equal to a reference value in the one or more images, the processor 410 may identify that a light source is disposed in the identified area.

For example, the processor 410 may perform three-dimensional modeling on a space where a wearable device 200 is located. The processor 410 may identify a virtual external space 750 based on the three-dimensional modeling. The processor 410 may identify a position where a light source is disposed within the virtual external space 750.

The processor 410 may identify that four light sources are disposed within the virtual external space 750 based on the one or more images of the external environment. The processor 410 may identify positions of the four light sources within the virtual external space 750.

As an example, the processor 410 may identify light generated by a lamp (or a bulb). The processor 410 may identify a light source 751, a light source 752, and a light source 753 within the virtual external space 750. The processor 410 may identify the light source 751, the light source 752, and the light source 753 from which light is emitted from one point.

As an example, the processor 410 may identify light generated by sunlight entering the space where the wearable device 200 is located through a window. The processor 410 may identify a light source 754 within the virtual external space 750. The processor 410 may identify the light source 754 from which light is emitted from a specified area.

According to an embodiment, the processor 410 may identify information on external environment where the wearable device 200 is located while at least one screen including a first screen is displayed. For example, the information on the external environment may include the virtual external space 750 including at least one light source, and a distribution image of a brightness value of the external environment. For example, the information on the external environment may include at least one of information on the number of the at least one light source, information on the brightest light source among the at least one light source, information on movement of the at least one light source, and information on illuminance according to the at least one light source.

For example, the processor 410 may configure the virtual external space 750 including the light source 751, the light source 752, the light source 753, and the light source 754. The processor 410 may identify the distribution image of the brightness value of the external environment based on the virtual external space 750. As an example, the distribution image of the brightness value of the external environment may indicate an absolute value of brightness at each of points within the virtual external space 750. As an example, the distribution image of the brightness value of the external environment may be identified based on a graph indicating a brightness value according to a position of the virtual external space 750.

According to an embodiment, the processor 410 may identify a screen to be displayed based on an application being executed. The processor 410 may correct the screen to be displayed based on the information on the external environment. For example, the processor 410 may correct the screen to be displayed so that the screen is displayed based on illuminance similar to the external environment. For example, the processor 410 may store the screen to be displayed in memory 415. The processor 410 may display the screen stored in the memory 415 in response to identifying that a display mode of the display 420 is changed from a first display mode to a second display mode.

According to an embodiment, the processor 410 may identify that a light source (e.g., the light source 751) is moved in the external environment. The processor 410 may identify a movement path of the light source and/or movement speed of the light source. The processor 410 may correct a screen based on the movement path of the light source and/or the movement speed of the light source.

According to an embodiment, the processor 410 may identify the brightest light source among a plurality of light sources in the external environment. For example, the processor 410 may identify whether the brightest light source is changed in the external environment. In the external environment, the processor 410 may correct a screen based on the brightest light source among the plurality of light sources.

According to an embodiment, the processor 410 may identify illuminance in the external environment. For example, the processor 410 may correct a screen based on identifying that the illuminance in the external environment is changed.

According to an embodiment, in a case that the screen to be displayed is corrected, a profile of a user 510 may be used. For example, the profile of the user 510 may include at least one of information on light/dark adaptation ability of the user 510, information on a brightness difference between pixels distinguishable by the user 510, information on a color difference between pixels distinguishable by the user 510, and information on color weakness. The processor 410 may correct the screen to be displayed based on the profile of the user 510. For example, the profile of the user 510 may be inputted from the user 510 or identified based on an operation performed by the user 510. For example, the profile of the user 510 may be identified based on physical information (e.g., age and gender) of the user 510.

For example, the processor 410 may correct the screen to be displayed based on a specified model (e.g., an artificial intelligence model) indicated by a plurality of parameters. As an example, the specified model may be configured according to a user. The specified model may be updated based on use history of the wearable device 200 of the user 510. According to an embodiment, the profile of the user 510 may be set as an input value of the specified model.

According to the above-described embodiment, the processor 410 may identify the second screen described in FIG. 6A based on correcting the screen to be displayed.

FIG. 8 is a flowchart of an operation of a wearable device according to an embodiment. In the following embodiment, each of operations may be sequentially performed, but is not necessarily performed sequentially. For example, an order of each of the operations may be changed, and at least two operations may be performed in parallel. Operation 810 to operation 830 may be related to the operation 630 of FIG. 6A.

In the operation 810, a processor 410 may identify whether a specified condition is satisfied. For example, after identifying information on external environment, the processor 410 may identify whether the specified condition is satisfied. For example, the specified condition may be used to identify whether to change a display mode of a display 420.

For example, the specified condition may be set to whether a specified input is received. The specified input may include an input for changing the display mode of the display 420. Based on identifying whether the specified input is received, the processor 410 may identify whether the specified condition is satisfied.

For example, the specified condition may be set to whether a value related to a motion of a wearable device 200 exceeds a specified value. The processor 410 may identify the value related to the motion of the wearable device 200. As an example, in a specified time of the wearable device 200, the larger the motion of the wearable device 200, the larger the value related to the motion of the wearable device 200 may be identified. The processor 410 may identify whether the specified condition is satisfied based on identifying whether the value related to the motion of the wearable device 200 exceeds the specified value.

For example, the specified condition may be set to whether a position of the wearable device 200 is outside a specified range. For example, the wearable device 200 may provide a service in a state of being located within the specified range. The processor 410 may identify whether the specified condition is satisfied based on identifying whether the position of the wearable device 200 is outside the specified range.

For example, the specified condition may be set to whether a change in illuminance of the external environment exceeds a threshold range. For example, the processor 410 may identify whether the specified condition is satisfied based on identifying whether the change in illuminance of the external environment exceeds the threshold range.

For example, the specified condition may be set to whether the number of light sources of the external environment is changed. For example, the processor 410 may identify whether the specified condition is satisfied based on identifying whether the number of light sources of the external environment exceeds a specified number.

For example, the specified condition may be set to whether a change in illuminance occurs according to movement of a light source. For example, the processor 410 may identify whether the specified condition is satisfied based on identifying whether the change in illuminance occurs according to the movement of the light source.

According to an embodiment, a plurality of conditions among examples of the above-described conditions may be configured as the specified condition by being combined. In a case that the plurality of conditions are configured as the specified condition by being combined, each determination criterion may be set lower.

In operation 820, in a case that the specified condition is satisfied, the processor 410 may change the display mode of the display 420 from a first display mode to a second display mode. For example, the processor 410 may change the display mode of the display 420 from the first display mode to the second display mode based on identifying that the specified condition is satisfied.

In the operation 830, in a case that the specified condition is not satisfied, the processor 410 may maintain the display mode of the display 420 as the first display mode. The processor 410 may maintain the display mode of the display 420 as the first display mode based on identifying that the specified condition is not satisfied.

In the operation 810 to the operation 830, an example in which the display mode of the display 420 changes from the first display mode to the second display mode as the display mode of the display 420 satisfies the specified condition in the first display mode is illustrated, but is not limited thereto. For example, as the display mode of the display 420 satisfies the specified condition in the second display mode, the display mode of the display 420 may be changed from the second display mode to the first display mode.

FIG. 9 is a flowchart of an operation of a wearable device according to an embodiment. In the following embodiment, each of operations may be sequentially performed, but is not necessarily performed sequentially. For example, an order of each of the operations may be changed, and at least two operations may be performed in parallel. Operation 910 to operation 950 may be related to the operation 650 of FIG. 6A.

Referring to FIG. 9, before the operation 910 is performed, a processor 410 may identify that a first area in a second screen identified according to a gaze of a user 510 corresponds to a second area in the second screen related to a position where a light source is disposed. The processor 410 may perform the operation 910 based on identifying that the first area corresponds to the second area.

In the operation 910, the processor 410 may identify whether a value related to a change in illumination is outside a first range. For example, the processor 410 may identify a value related to a change in illuminance between illuminance (e.g., average illuminance or maximum illuminance) for the first screen and illuminance for the second screen. The processor 410 may identify whether the value related to the change in illuminance is outside the first range. The illuminance for the first screen described above may mean an illuminance value recognized by the user 510 based on the display of the first screen. The illuminance for the second screen described above may mean an illuminance value recognized by the user 510 based on the display of the second screen.

For example, the processor 410 may identify whether the value related to the change in illumination is outside the first range in the first area corresponding to the second area. The processor 410 may identify whether the value related to the change in illumination is outside the first range in the first area identified according to the gaze of the user 510. The processor 410 may identify whether a significant change in illuminance occurs at a position of the gaze of the user 510. In a case that the significant change in illuminance occurs at the position of the gaze of the user 510, it may cause inconvenience to the user 510. Accordingly, the processor 410 may identify whether the value related to the change in illuminance is outside the first range.

For example, the first range may be set based on a specified model (e.g., an artificial intelligence model) indicated by a plurality of parameters. The processor 410 may change the first range based on learning data on a change in illuminance according to a change of the display mode of the display 420. As an example, the specified model may be configured according to a user. The specified model may be updated based on use history of the wearable device 200 of the user.

In operation 920, in a case that the value related to the change in illuminance is not outside the first range, the processor 410 may display the second screen through the display 420. For example, the second screen may be a screen that is not changed based on information on external environment. The processor 410 may display the second screen through the display 420 based on identifying that the value related to the change in illuminance is not outside the first range.

In operation 930, in a case that the value related to the change in illuminance is outside the first range, the processor 410 may identify whether a value related to brightness of a light source is outside a second range. For example, the processor 410 may identify whether the value related to the brightness of the light source is outside the second range based on identifying that the value related to the change in illuminance is outside the first range.

For example, the second area in the second screen may be related to the position where the light source is disposed. The processor 410 may identify whether a value related to brightness of the light source located in the second area is outside the second range.

According to an embodiment, the processor 410 may display a visual object in the first area corresponding to the second area. The processor 410 may display a visual object in the first area where the gaze of the user 510 is located. For example, in a case that the value related to the change in illuminance in the first area is outside the first range, the visual object may not be recognized by the user 510 due to the change in illuminance. In order to increase visibility of the visual object, the processor 410 may identify whether the value related to the brightness of the light source located in the second area is outside the second range. The processor 410 may increase the visibility of the visual object through operation 940 and the operation 950.

For example, the processor 410 may identify that the brightness of the light source may be outside a range that the display 420 may represent. For example, in a case that the brightness value of the light source is greater than a brightness value that an engine of the display 420 may output, visibility of content in an area corresponding to the light source may be lowered. Accordingly, the processor 410 may identify whether the value related to the brightness of the light source is outside the second range.

In the operation 940, in a case that the value related to the brightness of the light source is outside the second range, the processor 410 may change a position of the visual object displayed in the first area in the second screen. For example, based on identifying that the value related to the brightness of the light source is outside the second range, the processor 410 may change the position of the visual object displayed in the first area in the second screen.

In a case that the value related to the brightness of the light source of the second area (or the first area) is outside the second range, the visibility of the visual object may not be good even when the processor 410 reduces brightness of the second area corresponding to the light source. Accordingly, the processor 410 may change the position of the visual object from the first area corresponding to the second area to another area. For example, the processor 410 may display an element (e.g., an arrow) indicating that the position of the visual object has been changed, together with the visual object.

According to an embodiment, the processor 410 may display the visual object in the other area distinct from the first area corresponding to the second area in order to change the position of the gaze (or a region of interest (ROI)) of the user 510. For example, the processor 410 may track (or monitor) the gaze (or the ROI) of the user. The processor 410 may identify whether the user 510 views the first area in the second screen based on a gaze direction and an angle of view of the user. In a case of viewing the first area in the second screen, the user 510 may view a light source. This may cause inconvenience to the user 510. Accordingly, the processor 410 may display the visual object in the other area distinct from the first area corresponding to the second area in order to change the position of the gaze of the user 510. The processor 410 may induce the gaze of the user 510 to be moved by displaying the visual object in the other area different from the first area.

In the operation 950, in a case that the value related to the brightness of the light source is not outside the second range, the processor 410 may change data on the first area. For example, based on identifying that the value related to the brightness of the light source is not outside the second range, the processor 410 may change the data on the first area.

In a case that a value related to brightness of a light source of the first area (or the second area) is outside the second range, the processor 410 may reduce brightness of the first area (or illuminance recognized by the user 510 in the first area). The processor 410 may apply a filter for adjusting a light source in the first area.

For example, the processor 410 may change the data on the first area based on the filter for adjusting the light source. The processor 410 may reduce the brightness for the first area of the second screen by changing the data on the first area. Based on reducing the brightness for the first area of the second screen, the processor 410 may reduce illuminance recognized by the user 510 in a first area of the first screen.

For example, the processor 410 may display the filter for adjusting the light source on the second screen of a second virtual space displayed through the display 420. The filter for adjusting the light source may be used to block at least a portion of light emitted from the light source. As an example, the filter for adjusting the light source may include a gray scale image. The processor 410 may display the gray scale image in the first area to reduce the illuminance recognized by the user 510 in the first area. As an example, the processor 410 may reduce the brightness of the first area based on overlaying the gray scale image on the first area. Based on overlaying the gray scale image on the first area, the processor 410 may reduce the brightness of the first area within a brightness adaptable range of the user.

According to an embodiment, the processor 410 may apply the filter for adjusting the light source to the first area corresponding to the second area in a state in which the position of the gaze (or the region of interest (ROI)) of the user 510 is maintained. In a case of viewing the first area, the user 510 may view the light source. This may cause inconvenience to the user 510. Accordingly, the processor 410 may apply the filter for adjusting the light source to the first area to prevent or reduce a sudden change in illuminance in the first area.

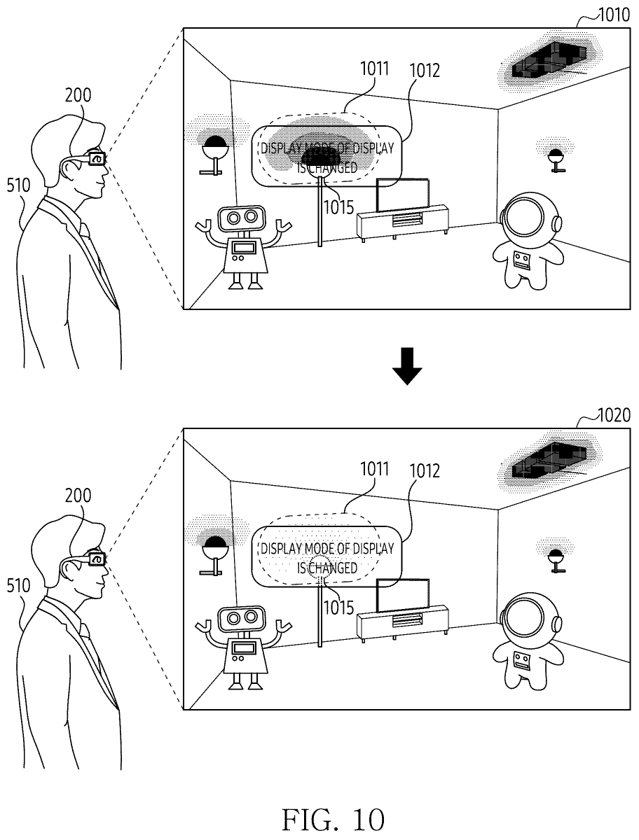

FIG. 10 illustrates an example of an operation of a wearable device according to an embodiment.

Referring to FIG. 10, a processor 410 may identify that a display mode of a display 420 is changed from a first display mode to a second display mode. The processor 410 may identify a second screen 1010 related to a second virtual space according to the second display mode based on identifying that the display mode of the display 420 is changed from the first display mode to the second display mode. For example, the processor 410 may identify the second screen 1010 based on the operation 640 of FIG. 6A.

According to an embodiment, the processor 410 may identify a first area in the second screen 1010 according to a gaze of a user 510. The processor 410 may identify a second area in the second screen 1010 related to a position where a light source 1015 is disposed. For example, the processor 410 may identify that the first area corresponds to the second area. The processor 410 may identify that the first area corresponds to an area 1011, and the second area corresponds to the area 1011. For example, the light source 1015 may be displayed on the area 1011 in the second screen 1010. The gaze of the user 510 may be located in the area 1011 in the second screen 1010.

According to an embodiment, in the second screen 1010, a visual object 1012 may be displayed on the area 1011. The processor 410 may display the visual object 1012 on the area 1011 where the gaze of the user 510 is located. For example, the visual object 1012 may indicate that the display mode of the display 420 has been changed. For example, in a case that the visual object 1012 is displayed on the area 1011 where the light source 1015 is disposed, visibility may decrease. The processor 410 may increase visibility of the visual object 1012 by changing data on the first area.

According to an embodiment, the processor 410 may change the data on the first area based on identifying that a value related to brightness of the light source 1015 is not outside a second range.

According to an embodiment, the processor 410 may change the second screen 1010 to a third screen 1020 based on identifying that the visual object 1012 is displayed on the area 1011 where the light source 1015 is disposed.

For example, the processor 410 may change the second screen 1010 to the third screen 1020 based on changing data on the area 1011. As an example, the processor 410 may apply a filter for adjusting a light source to the area 1011. The processor 410 may change the data on the area 1011 based on applying the filter for adjusting the light source to the area 1011. The processor 410 may change brightness (or illuminance recognized by the user) of the area 1011 based on changing the data on the area 1011.

For example, the processor 410 may display the filter for adjusting the light source (e.g., a gray scale image) on the area 1011. For example, the filter for adjusting the light source may be used to block at least a portion of light emitted from the light source. The processor 410 may change the second screen 1010 to the third screen 1020 based on displaying the filter for adjusting the light source on the area 1011.

According to an embodiment, as the filter for adjusting the light source is applied (or displayed), the processor 410 may improve the visibility of the visual object 1012, in the third screen 1020.

In the above-described embodiment, an example in which the filter for adjusting the light source is applied (or displayed) to the area 1011 to improve the visibility of the visual object 1012 has been described, but is not limited thereto. For example, even when the visual object 1012 is not displayed, the processor 410 may apply the light source adjustment filter to the area 1011 to reduce a change in illumination that exceeds a threshold range recognized by the user 510.

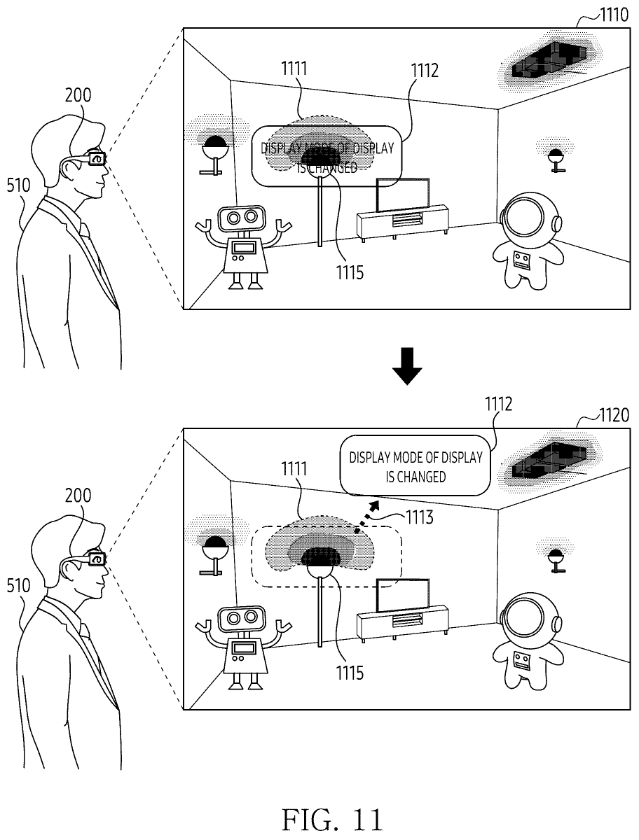

FIG. 11 illustrates an example of an operation of a wearable device according to an embodiment.

Referring to FIG. 11, a processor 410 may identify that a display mode of a display 420 is changed from a first display mode to a second display mode. Based on identifying that the display mode of the display 420 is changed from the first display mode to the second display mode, the processor 410 may identify a second screen 1110 related to a second virtual space according to the second display mode. For example, the processor 410 may identify the second screen 1110 based on the operation 640 of FIG. 6A.

According to an embodiment, the processor 410 may identify a first area in the second screen 1110 according to a gaze of a user 510. The processor 410 may identify a second area in the second screen 1110 related to a position where a light source 1115 is disposed. For example, the processor 410 may identify that the first area corresponds to the second area. The processor 410 may identify that the first area corresponds to an area 1111, and the second area corresponds to the area 1111. For example, the light source 1115 may be displayed on the area 1111 in the second screen 1110. The gaze of the user 510 may be located in the area 1111 in the second screen 1110.

According to an embodiment, in the second screen 1110, a visual object 1112 may be displayed on the area 1111. The processor 410 may display the visual object 1112 on the area 1111 where the gaze of the user 510 is located. For example, the visual object 1112 may indicate that the display mode of the display 420 has been changed. For example, in a case that the visual object 1112 is displayed on the area 1111 where the light source 1115 is disposed, visibility may decrease. The processor 410 may increase visibility of the visual object 1112 by changing a position of the visual object 1112.

According to an embodiment, the processor 410 may change the position of the visual object 1112 based on identifying that the value related to brightness of the light source 1115 is outside a second range. For example, as described in FIG. 10, even when the processor 410 applies a filter for adjusting a light source to an area corresponding to the light source 1115, the visibility of the visual object 1112 may not increase. For example, in a case that the brightness of the light source 1115 is too bright, the brightness of the light source 1115 may be outside a range that the display 420 may represent. The processor 410 may change the position of the visual object 1112 based on identifying that the brightness of the light source 1115 is outside the range that the display 420 may represent.

According to an embodiment, the processor 410 may change the second screen 1110 to a third screen 1120 based on the visual object 1112 being displayed on the area 1111 where the light source 1115 is disposed.

For example, the processor 410 may change the second screen 1110 to the third screen 1130 based on changing the position of the visual object 1112. As an example, the processor 410 may identify that the visual object 1112 is displayed on the area 1111 where the light source 1115 is disposed. The processor 410 may identify at least one light source distinct from the light source 1115 in the second screen 1110. The processor 410 may change the position of the visual object 1112 to an area distinct from an area in which the at least one light source is displayed. The processor 410 may display an element 1113 indicating that the visual object 1112 has been moved in the third screen 1120, together with the visual object 1112.

In FIG. 11, a shape of the element 1113 is illustrated in a shape of an arrow, but is not limited thereto. For example, the element 1113 may be configured to indicate an animation effect in which the object 1112 is moved. For example, the element 1113 may be configured to indicate a shadow effect displayed at a position before the object 1112 is moved.

For example, the processor 410 may identify an area in which the visibility of the visual object 1112 is best, within the second screen 1110. The processor 410 may change the position of the visual object 1112 to the identified area. For example, the processor 410 may identify a color and/or brightness of the visual object 1112. The processor 410 may identify an area in which the visual object 1112 is to be displayed based on colors and/or brightness of objects in the second virtual space. The processor 410 may change the second screen 1110 to the third screen 1120 based on changing the position of the visual object 1112 to the identified area.

According to an embodiment, the processor 410 may apply the filter for adjusting the light source in FIG. 10 and change the position of the visual object 1112. For example, a filter applied for light source adjustment and/or a position where the visual object 1112 is changed may be set based on an application being executed in a wearable device 200 and/or a service provided by the wearable device 200. For example, the filter applied for light source adjustment and/or the position where the visual object 1112 is changed may be set based on a preference of the user.

In the above-described embodiment, an example in which the position of the visual object 1112 is changed in order to improve the visibility of the visual object 1112 has been described, but is not limited thereto. For example, the processor 410 may display the visual object 1112 in another area to move the gaze of the user 510 from the area 1111 to the other area.

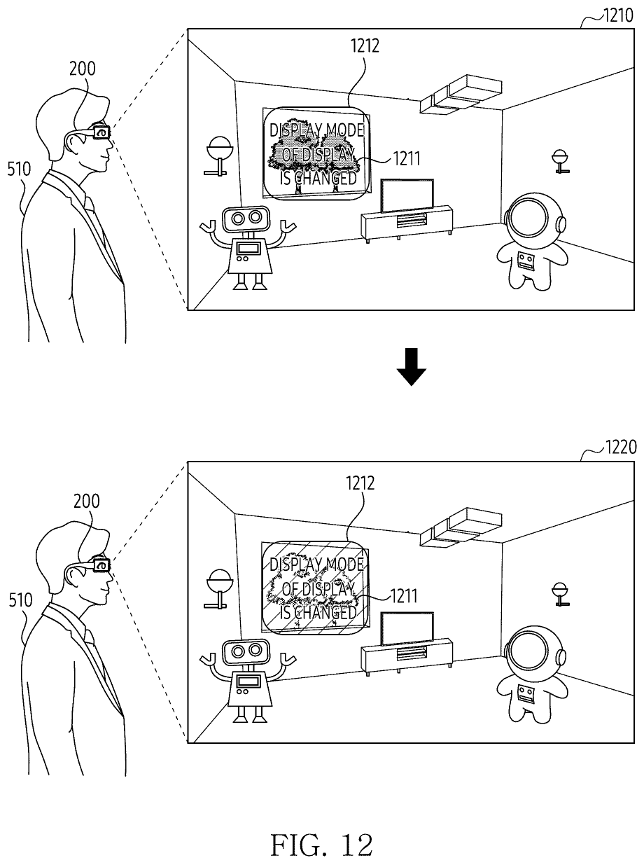

FIG. 12 illustrates an example of an operation of a wearable device according to an embodiment.

Referring to FIG. 12, a processor 410 may identify that a display mode of a display 420 is changed from a first display mode to a second display mode. Based on identifying that the display mode of the display 420 is changed from the first display mode to the second display mode, the processor 410 may identify a second screen 1210 related to a second virtual space according to the second display mode. For example, the processor 410 may identify the second screen 1210 based on the operation 640 of FIG. 6A.

According to an embodiment, in the second screen 1210, the processor 410 may identify that an area in which a visual object 1212 is displayed corresponds to an area in which an object 1211 is displayed. The processor 410 may identify information on the object 1211. For example, the processor 410 may identify a color of the object 1211. The processor 410 may identify that the color of the object 1211 corresponds to a color of the visual object 1212.

For example, in a case that the color of the object 1211 corresponds to the color of the visual object 1212, visibility of the visual object 1212 may be lowered. The processor 410 may change a feature of the visual object 1212. As an example, the processor 410 may change the color of the visual object 1212.

According to an embodiment, the processor 410 may change the second screen 1210 to a third screen 1220 based on changing the feature of the visual object 1212. For example, the processor 410 may change the second screen 1210 to the third screen 1220 based on changing the color of the visual object 1212. The processor 410 may improve the visibility of the visual object 1212 based on changing the color of the visual object 1212.

In FIG. 12, an example in which the color of the visual object 1212 is changed in a case that the color of the object 1211 corresponds to the color of the visual object 1212 is illustrated, but is not limited thereto. In a case that the color of the object 1211 corresponds to the color of the visual object 1212, the processor 410 may change at least one of a shape, a size, and/or transparency of the visual object 1212.

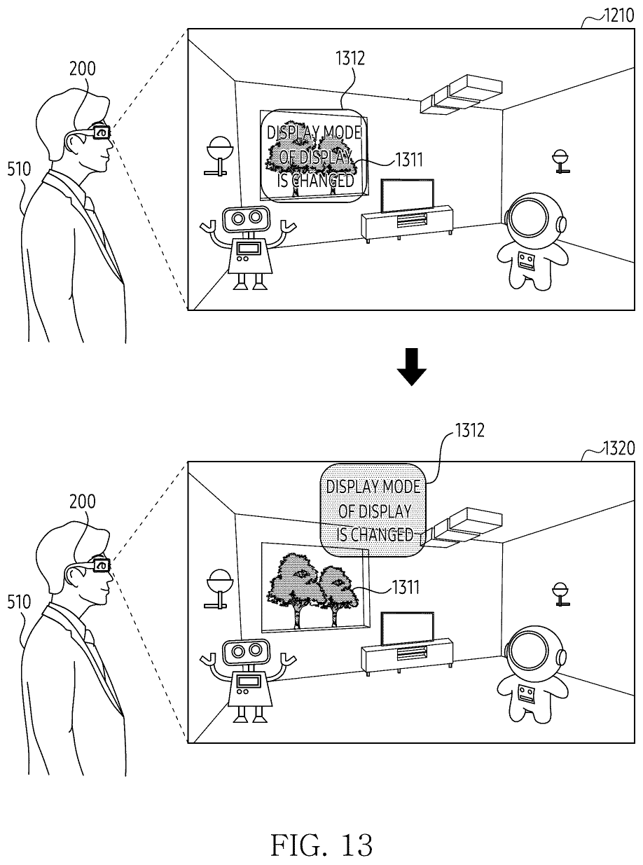

FIG. 13 illustrates an example of an operation of a wearable device according to an embodiment.

Referring to FIG. 13, a processor 410 may identify that a display mode of a display 420 is changed from a first display mode to a second display mode. Based on identifying that the display mode of the display 420 is changed from the first display mode to the second display mode, the processor 410 may identify a second screen 1310 related to a second virtual space according to the second display mode. For example, the second screen 1310 may correspond to the second screen 1210 of FIG. 12.

According to an embodiment, in a case that a color of an object 1311 corresponds to a color of a visual object 1312, visibility of the visual object 1312 may be lowered. The processor 410 may change a position of the visual object 1312.

For example, the processor 410 may identify a position at which the visual object 1312 is to be moved in the second screen 1310, based on the color of the visual object 1312. The processor 410 may move the visual object 1312 to the identified position.

According to an embodiment, the processor 410 may change the second screen 1310 to a third screen 1320 based on changing the position of the visual object 1312. The processor 410 may improve the visibility of the visual object 1312 based on changing the position of the visual object 1312.

According to an embodiment, a wearable device may comprise a display, a camera, at least one sensor, memory, storing instructions, comprising one or more storage media, and at least one processor. The instructions, when executed by the at least one processor individually or collectively, may cause the wearable device to display a first screen related to a first virtual space through the display while a display mode of the display is a first display mode. The instructions, when executed by the at least one processor individually or collectively, may cause the wearable device to identify information on external environment in which the wearable device is located, while at least one screen related to the first virtual space, including the first screen, is displayed. The instructions, when executed by the at least one processor individually or collectively, may cause the wearable device to, after the information on the external environment is identified, identify that the display mode of the display is changed from the first display mode to a second display mode. The instructions, when executed by the at least one processor individually or collectively, may cause the wearable device to, based on identifying that the display mode of the display is changed from the first display mode to the second display mode, identify a second screen related to a second virtual space according to the second display mode. The instructions, when executed by the at least one processor individually or collectively, may cause the wearable device to display a third screen changed from the second screen through the display while the display mode of the display is the second display mode, based on the information on the external environment and a first area in the second screen identified according to a gaze of a user of the wearable device.

According to an embodiment, the information on the external environment may include information on a position where a light source is disposed, within a space where the wearable device is located.

According to an embodiment, the instructions, when executed by the at least one processor individually or collectively, may cause the wearable device to identify information on brightness of one or more images of the external environment obtained through the camera. The instructions, when executed by the at least one processor individually or collectively, may cause the wearable device to, based on the information on the brightness of the one or more images of the external environment, identify the information on the position where the light source is disposed within the space where the wearable device is located.

According to an embodiment, the instructions, when executed by the at least one processor individually or collectively, may cause the wearable device to identify that the first area in the second screen identified according to the gaze of the user, corresponds to a second area in the second screen related to the position where the light source is disposed. The instructions, when executed by the at least one processor individually or collectively, may cause the wearable device to, based on identifying that the first area corresponds to the second area, change data for the first area in the second screen. The instructions, when executed by the at least one processor individually or collectively, may cause the wearable device to, based on changing the data for the first area in the second screen, identify the third screen changed from the second screen.

According to an embodiment, the instructions, when executed by the at least one processor individually or collectively, may cause the wearable device to display the second screen through the display while the display mode of the display is the second display mode, based on identifying that the first area is distinct from the second area.

According to an embodiment, the instructions, when executed by the at least one processor individually or collectively, may cause the wearable device to identify, based on identifying that the first area corresponds to the second area, information on brightness of the light source. The instructions, when executed by the at least one processor individually or collectively, may cause the wearable device to, based on the information on the brightness of the light source, change a position of a visual object displayed on the first area in the second screen. The instructions, when executed by the at least one processor individually or collectively, may cause the wearable device to identify the third screen changed from the second screen based on changing the position of the visual object displayed on the first area in the second screen.

According to an embodiment, the instructions, when executed by the at least one processor individually or collectively, may cause the wearable device to display an element indicating that the visual object has been moved in the third screen.

According to an embodiment, the instructions, when executed by the at least one processor individually or collectively, may cause the wearable device to identify another position in the second screen distinct from the position where the light source is disposed. The instructions, when executed by the at least one processor individually or collectively, may cause the wearable device to change at least one of the position of the visual object or a feature of the visual object, based on information on an object displayed on the another position.

According to an embodiment, the instructions, when executed by the at least one processor individually or collectively, may cause the wearable device to identify, using the at least one sensor, a value related to a motion of the wearable device. The instructions, when executed by the at least one processor individually or collectively, may cause the wearable device to change the display mode of the display from the first display mode to the second display mode based on the value related to the motion of the wearable device exceeding a specified value.

According to an embodiment, the first virtual space according to the first display mode may be configured to be distinct from the space where the wearable device is located. The second virtual space according to the second display mode may be configured to include the space and one or more visual objects displayed overlappingly in the space.

According to an embodiment, a method of a wearable device may comprise displaying a first screen related to a first virtual space through the display while a display mode of the display is a first display mode. The method may comprise identifying information on external environment in which the wearable device is located, while at least one screen related to the first virtual space, including the first screen, is displayed. The method may comprise, after the information on the external environment is identified, identifying that the display mode of the display is changed from the first display mode to a second display mode. The method may comprise, based on identifying that the display mode of the display is changed from the first display mode to the second display mode, identifying a second screen related to a second virtual space according to the second display mode. The method may comprise displaying a third screen changed from the second screen through the display while the display mode of the display is the second display mode, based on the information on the external environment and a first area in the second screen identified according to a gaze of a user of the wearable device.

According to an embodiment, the information on the external environment may include information on a position where a light source is disposed, within a space where the wearable device is located.

According to an embodiment, the method may comprise identifying information on brightness of one or more images of the external environment obtained through the camera. The method may comprise, based on the information on the brightness of the one or more images of the external environment, identifying the information on the position where the light source is disposed within the space where the wearable device is located.

According to an embodiment, the method may comprise identifying that the first area in the second screen identified according to the gaze of the user, corresponds to a second area in the second screen related to the position where the light source is disposed. The method may comprise, based on identifying that the first area corresponds to the second area, changing data for the first area in the second screen. The method may comprise, based on changing the data for the first area in the second screen, identifying the third screen changed from the second screen.

According to an embodiment, the method may comprise displaying the second screen through the display while the display mode of the display is the second display mode, based on identifying that the first area is distinct from the second area.

According to an embodiment, the method may comprise identifying, based on identifying that the first area corresponds to the second area, information on brightness of the light source. The method may comprise, based on the information on the brightness of the light source, changing a position of a visual object displayed on the first area in the second screen. The method may comprise identifying the third screen changed from the second screen based on changing the position of the visual object displayed on the first area in the second screen.

According to an embodiment, the method may comprise displaying an element indicating that the visual object has been moved in the third screen.

According to an embodiment, the method may comprise identifying another position in the second screen distinct from the position where the light source is disposed. The method may comprise changing at least one of the position of the visual object or a feature of the visual object, based on information on an object displayed on the another position.

According to an embodiment, the method may comprise identifying, using at least one sensor of the wearable device, a value related to a motion of the wearable device. The method may comprise changing the display mode of the display from the first display mode to the second display mode based on the value related to the motion of the wearable device exceeding a specified value.

According to an embodiment, a non-transitory computer readable storage medium may store one or more programs. The one or more programs may comprise instructions, which, when executed by at least one processor of a wearable device with a display, a camera, and at least one sensor, cause the wearable device to display a first screen related to a first virtual space through the display while a display mode of the display is a first display mode. The one or more programs may comprise instructions, which cause the wearable device to identify information on external environment, while at least one screen related to the first virtual space, including the first screen, is displayed. The one or more programs may comprise instructions, which cause the wearable device to, after the information on the external environment is identified, identify that the display mode of the display is changed from the first display mode to a second display mode. The one or more programs may comprise instructions, which cause the wearable device to, based on identifying that the display mode of the display is changed from the first display mode to the second display mode, identify a second screen related to a second virtual space according to the second display mode. The one or more programs may comprise instructions, which cause the wearable device to display a third screen changed from the second screen through the display while the display mode of the display is the second display mode, based on the information on the external environment and a first area in the second screen identified according to a gaze of a user of the wearable device. “Based on” as used herein covers based at least on.

According to the above-described embodiment, a wearable device (e.g., the wearable device 200) may switch a display mode of a display from an AR mode to a VR mode. The wearable device (e.g., the wearable device 200) may switch the display mode of the display from the VR mode to the AR mode. In a case that the display mode of the display is switched, illuminance perceived by a user may change according to brightness of content and/or an external environment. The wearable device may change a screen to reduce the change in the illuminance perceived by the user. As the wearable device changes the screen, the user may continuously gaze at the content even when the switching of the display mode of the display is performed.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via at least a third element(s). Thus, for example, “connected” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable device comprising:
a display;
a camera;
at least one sensor;
memory, storing instructions, comprising one or more storage media; and
at least one processor comprising processing circuitry, wherein the instructions, when executed by the at least one processor individually and/or collectively, cause the wearable device to:
display a first screen related to a first virtual space via the display while a display mode of the display is a first display mode,
identify information regarding external environment in which the wearable device is located, while at least one screen related to the first virtual space, including the first screen, is displayed,
after the information regarding the external environment is identified, identify that the display mode of the display is and/or has changed from the first display mode to a second display mode,
based on identifying that the display mode of the display is and/or has changed from the first display mode to the second display mode, identify a second screen related to a second virtual space based on the second display mode, and
display a third screen changed from the second screen via the display while the display mode of the display is the second display mode, based on the information regarding the external environment and a first area in the second screen identified based on a gaze of a user of the wearable device.

2. The wearable device of claim 1, wherein the information regarding the external environment includes information regarding a position where a light source is disposed, within a space where the wearable device is located.

3. The wearable device of claim 2, wherein the instructions, when executed by the at least one processor individually and/or collectively, cause the wearable device to:
identify information regarding brightness of one or more images of the external environment obtained via the camera, and
based on the information regarding the brightness of the one or more images of the external environment, identify the information regarding the position where the light source is disposed within the space where the wearable device is located.

4. The wearable device of claim 2, wherein the instructions are, when executed by the at least one processor individually and/or collectively, cause the wearable device to:
identify that the first area in the second screen identified based on the gaze of the user, corresponds to a second area in the second screen related to the position where the light source is disposed,
based on identifying that the first area corresponds to the second area, change data for the first area in the second screen, and
based on changing the data for the first area in the second screen, identify the third screen changed from the second screen, and
wherein device is configured so that the first area in the second screen is identified based on identifying that a value related to brightness in the first area is greater than or equal to a specified value.

5. The wearable device of claim 4, wherein the instructions, when executed by the at least one processor individually and/or collectively, cause the wearable device to display the second screen via the display while the display mode of the display is the second display mode, based on identifying that the first area is distinct from the second area.

6. The wearable device of claim 4, wherein the instructions, when executed by the at least one processor individually and/or collectively, cause the wearable device to:
identify, based on identifying that the first area corresponds to the second area, information regarding brightness of the light source,
based on the information regarding the brightness of the light source, change a position of a visual object displayed on the first area in the second screen, and
identify the third screen changed from the second screen based on changing the position of the visual object displayed on the first area in the second screen.

7. The wearable device of claim 6, wherein the instructions, when executed by the at least one processor individually and/or collectively, cause the wearable device to display an element indicating that the visual object has been moved in the third screen.

8. The wearable device of claim 6, wherein the instructions, when executed by the at least one processor individually and/or collectively, cause the wearable device to:
identify another position in the second screen distinct from the position where the light source is disposed, and
change at least one of the position of the visual object or a feature of the visual object, based on information regarding an object displayed on the another position.

9. The wearable device of claim 1, wherein the instructions, when executed by the at least one processor individually and/or collectively, cause the wearable device to:
identify, via the at least one sensor, a value related to a motion of the wearable device, and
change the display mode of the display from the first display mode to the second display mode based on the value related to the motion of the wearable device exceeding a specified value.

10. The wearable device of claim 1, wherein the first virtual space is configured to be distinct from the space where the wearable device is located, and
wherein the second virtual space, based on the second display mode, is configured to include the space and one or more visual objects displayed overlappingly in the space.

11. A method of a wearable device, the method comprising:
displaying a first screen related to a first virtual space via a display of the wearable device while a display mode of the display is a first display mode,
identifying information regarding an external environment in which the wearable device is located, while at least one screen related to the first virtual space, including the first screen, is displayed,
after the information regarding the external environment is identified, identifying that the display mode of the display is and/or has changed from the first display mode to a second display mode,
based on identifying that the display mode of the display is and/or has changed from the first display mode to the second display mode, identifying a second screen related to a second virtual space based on the second display mode, and
displaying a third screen changed from the second screen via the display while the display mode of the display is the second display mode, based on the information regarding the external environment and a first area in the second screen identified based on a gaze of a user of the wearable device.

12. The method of claim 11, wherein the information regarding the external environment includes information regarding a position where a light source is disposed, within a space where the wearable device is located.

13. The method of claim 12, wherein the method further comprises:
identifying information regarding brightness of one or more images of the external environment obtained via a camera of the wearable device, and
based on the information regarding the brightness of the one or more images of the external environment, identifying the information regarding the position where the light source is disposed within the space where the wearable device is located.

14. The method of claim 12, wherein the method further comprises:
identifying that the first area in the second screen identified based on the gaze of the user, corresponds to a second area in the second screen related to the position where the light source is disposed,
based on identifying that the first area corresponds to the second area, changing data for the first area in the second screen, and
based on changing the data for the first area in the second screen, identifying the third screen changed from the second screen.

15. The method of claim 14, wherein the method further comprises displaying the second screen via the display while the display mode is the second display mode, based on identifying that the first area is distinct from the second area.

16. The method of claim 14, wherein the method further comprises:
identifying, based on identifying that the first area corresponds to the second area, information regarding brightness of the light source,
based on the information regarding the brightness of the light source, changing a position of a visual object displayed on the first area in the second screen, and
identifying the third screen changed from the second screen based on changing the position of the visual object displayed on the first area in the second screen.

17. The method of claim 16, wherein the method further comprises displaying an element indicating that the visual object has been moved in the third screen.

18. The method of claim 16, wherein the method further comprises:
identifying another position in the second screen distinct from the position where the light source is disposed, and
changing at least one of the position of the visual object or a feature of the visual object, based on information regarding an object displayed on the another position.

19. The method of claim 11, wherein the method further comprises:
identifying, using at least one sensor of the wearable device, a value related to a motion of the wearable device, and
changing the display mode of the display from the first display mode to the second display mode based on the value related to the motion of the wearable device exceeding a specified value.

20. A non-transitory computer readable storage medium storing one or more programs, the one or more programs comprising instructions, which, when executed by a processor of a wearable device comprising a display, a camera, and at least one sensor, cause the wearable device to:
display a first screen related to a first virtual space via the display while a display mode of the display is a first display mode,
identify information regarding an external environment, while at least one screen related to the first virtual space, including the first screen, is displayed,
after the information regarding the external environment is identified, identify that the display mode of the display is changed from the first display mode to a second display mode,
based on identifying that the display mode of the display is changed from the first display mode to the second display mode, identify a second screen related to a second virtual space according to the second display mode, and
display a third screen changed from the second screen via the display while the display mode of the display is the second display mode, based on the information regarding the external environment and a first area in the second screen identified according to a gaze of a user of the wearable device.
